(19) United States
(12) Patent Application Publication
(10) Pub. No.: US 2025/0052978 A1
(43) Pub. Date: Feb. 13, 2025

(54) CAMERA DEVICE AND OPTICAL DEVICE COMPRISING SAME

(71) Applicant: LG INNOTEK CO., LTD., Seoul (KR)

(72) Inventor: Sung Guk LEE, Seoul (KR)

(73) Assignee: LG INNOTEK CO., LTD., Seoul (KR)

(21) Appl. No.: 18/719,481

(22) PCT Filed: Feb. 1, 2023
(86) PCT No.: PCT/KR2023/001435

§ 371 Date: Jun. 13, 2024

(30) Foreign Application Priority Data
Feb. 7, 2022 (KR) 10-2022-0015741

(51) Int. Cl. G02B 7/182; G02B 13/00; G03B 5/00

(52) U.S. Cl. CPC G02B 7/1821; G02B 13/0065; G03B 5/00; G03B 2205/0023; G03B 2205/0069

(57) ABSTRACT

An embodiment includes: a housing, a holder disposed in the housing, an optical member disposed on the holder, a driving plate disposed between the holder and the housing and supporting the holder, a support part spaced apart from the driving plate and coupled to the holder, and a first magnetic body disposed on the support part, a second magnetic body facing the first magnetic body in a first direction and disposed on the housing, and a plate disposed on the support part and facing the first magnetic body in the first direction.

### CROSS REFERENCE TO RELATED APPLICATIONS

This application is the National Phase of PCT/KR2023/001435 filed on Feb. 1, 2023, which claims priority under 35 U.S.C. § 119 (a) to patent Application No. 10-2022-0015741 filed in the Republic of Korea on Feb. 7, 2022, all of which are hereby expressly incorporated by reference into the present application.

### TECHNICAL FIELD

Embodiments relate to a camera device and an optical instrument including the same.

### BACKGROUND ART

A camera device is a device for taking pictures or videos of a subject, and is mounted in portable devices, drones, vehicles, and the like. In order to improve image quality, a camera device may have an image stabilization (IS) function for correcting or preventing shaking of an image caused by movement of a user, e.g., optical image stabilizer (OIS), an autofocus (AF) function, and/or a zoom function.

### DISCLOSURE

### Technical Problem

Embodiments provide a camera device capable of preventing damage to the magnetic body support part due to impact and allowing the driving plate to stably support the holder.

### Technical Solution

A camera device according to an embodiment includes a housing; a holder disposed in the housing; an optical member disposed on the holder; a driving plate disposed between the holder and the housing and configured to support the holder; a support part spaced apart from the driving plate and coupled to the holder; a first magnetic body disposed on the support part; a second magnetic body disposed on the housing so as to face the first magnetic body in a first direction; and a plate disposed at the support part so as to face the first magnetic body in the first direction.

The support part may include a body and an extension portion extending from the body, passing through the housing and being coupled to the holder.

The plate may be disposed at the body of the support part. The plate may be a magnetic body plate. Or the plate may be non-magnetic.

The first magnetic body may be disposed between the second magnetic body and the plate.

The support part may be formed of resin and a plastic and the plate is a metal plate.

The first magnetic body may include a first magnet, and the second magnetic body may include a second magnet, and a repulsive force may act between the first magnetic body and the second magnetic body.

The body may include a magnetic body part facing the first magnetic body in the first direction, and the extension portion may be non-magnetic body.

The plate may be a non-magnetic body, and include a magnetic body plate facing the first magnetic body in the first direction.

The plate may be disposed on the body and the extension portion of the support part. The plate may be disposed inside the support part.

The first magnetic body may be disposed on a front surface of the support part facing the second magnetic body in the first direction, and the plate may be disposed on a rear surface of the support part which is opposite to the front surface of the support part.

A camera device according to an another embodiment includes a housing; a holder disposed in the housing; an optical member disposed on the holder; a driving plate disposed between a first side portion of the holder and the housing and supporting the holder; a support part disposed to be opposite to the first side portion of the holder and comprising a portion that passes through the housing and is coupled to the first side portion of the holder; a magnet disposed on a second side portion of the holder; a coil facing the magnet and disposed on the housing; a first magnetic body disposed on the support part; a second magnetic body facing the first magnetic body in a first direction and disposed on the housing; and a plate disposed on the support part to face the first magnetic body in the first direction.

The plate may include a magnetic body portion and a non-magnetic body portion, and the magnetic body portion among the magnetic body portion and the non-magnetic body portion may be disposed closer to the first magnetic body than the non-magnetic body portion.

The magnetic portion among the magnetic body portion and the non-magnetic body portion may be disposed farther from the magnet than the non-magnetic portion.

### Advantageous Effects

Embodiments may include a plate having greater rigidity than the magnetic support which is disposed at the magnetic body support part and improve a rigidity of the magnetic body support part including the plate and prevent the magnetic body support part from being damaged by impact and prevent cracks from occurring in the magnetic body support part.

Embodiments may increase a repulsive force between the first and second magnetic bodies, and allow the driving plate to stably support the holder, and thereby perform stable OIS operation and secure the reliability of OIS operation.

### DESCRIPTION OF DRAWINGS

FIG. 1 is a perspective view of a camera device according to an embodiment.

FIG. 2 is an exploded perspective view of the camera device in FIG. 1.

FIG. 3 is a cross-sectional view of the camera device taken along line AB in FIG. 1.

FIG. 4 is a perspective view of a second actuator shown in FIG. 1.

FIG. 5 is an exploded perspective view of the second actuator.

FIG. 6A is a front perspective view of a holder in FIG. 5.

FIG. 6B is a rear perspective view of the holder.

FIG. 6C is a lower perspective view of the holder.

FIG. 7 is an exploded perspective view of the holder, a driving plate, and a magnetic body support part.

FIG. 8A is an exploded perspective view of the holder, to which an optical member, the driving plate, and an OIS magnet are coupled, and the magnetic body support part.

FIG. 8B is a coupled perspective view of the optical member, the driving plate, the OIS magnet, and the magnetic body support part.

FIG. 9A is a first perspective view of a first housing.

FIG. 9B is a second perspective view of the first housing.

FIG. 9C is an exploded perspective view of the first housing and a second magnetic body.

FIG. 10 is a perspective view of the first housing, the holder, the optical member, a first circuit board, and a cover plate.

FIG. 11 is a perspective view of the first magnetic body, the second magnetic body, the plate, and the magnetic body support part.

FIG. 12 is a view for explaining electromagnetic force and movement of the driving plate according to interaction between first to third OIS magnets and first to third coil units.

FIG. 13A is a cross-sectional view of the second actuator taken along line CD in FIG. 4.

FIG. 13B is a cross-sectional view of the second actuator taken along line EF in FIG. 4.

FIG. 14 is a cross-sectional view of the second actuator according to a comparative embodiment.

FIG. 15a is a perspective view of the second actuator including the plate according to another embodiment.

FIGS. 15b and 15c are perspective views of the plate in FIG. 15a.

FIG. 16a is a cross-sectional view of the second actuator according to another embodiment.

FIG. 16b is a perspective view of the plate and the magnetic body plate in FIG. 16a.

FIG. 17a is a cross-sectional view of a second actuator according to another embodiment.

FIG. 17b is a perspective view of the driving plate on which the plate in FIG. 17a is disposed.

FIG. 18a is a cross-sectional view of a second actuator according to another embodiment.

FIG. 18B is a perspective view of the first housing in which the plate in FIG. 18A is disposed.

FIG. 19a is a cross-sectional view of the second actuator according to another embodiment.

FIG. 19B is a perspective view of the magnetic body support part on which the plate in FIG. 19A is disposed.

FIG. 19C is a cross-sectional view of the second actuator including the plate according to another embodiment.

FIG. 20 is a cross-sectional view of the second actuator including the plate according to another embodiment.

FIG. 21A is a cross-sectional view of the second actuator including the plate according to another embodiment.

FIG. 21B is a cross-sectional view of the second actuator including the plate according to another embodiment.

FIG. 22 is a perspective view of the first actuator and the image sensing unit according to the embodiment.

FIG. 23A is a first exploded perspective view of the first actuator and the image sensing unit in FIG. 22.

FIG. 23B is a second exploded perspective view of the first actuator and the image sensing unit in FIG. 22.

FIG. 24A is a cross-sectional view of the first actuator and the image sensing unit taken along line ab in FIG. 22.

FIG. 24B is a cross-sectional view of the first actuator and the image sensing unit taken along line cd in FIG. 22.

FIG. 25 is an exploded perspective view of the first actuator.

FIG. 26A is an exploded perspective view of a second housing.

FIG. 26B is a perspective view of a body of the second housing.

FIG. 27A is a first perspective view of first and second guide parts and a lens unit.

FIG. 27B is a second perspective view of the first and second guide parts and the lens unit.

FIG. 28 is an exploded perspective view of first and second magnets and the lens unit.

FIG. 29 is a functional block diagram of the camera device according to the embodiment.

FIG. 30 is a perspective view of an optical instrument according to an embodiment.

FIG. 31 is a configuration diagram of the optical instrument shown in FIG. 30.

### BEST MODE

Hereinafter, embodiments of the present disclosure, which may concretely realize the objects described above, will be described with reference to the accompanying drawings.

In the following description of the embodiments, it will be understood that, when each element is referred to as being “on” or “under” another element, it can be directly on or under the other element, or can be indirectly formed such that one or more intervening elements are also present. In addition, when an element is referred to as being “on or under,” “under the element” as well as “on the element” may be included based on the element.

In addition, the relational terms “first,” “second,” “on/upper part/above,” and “under/lower part/below” are used herein only to distinguish between one subject or element and another subject or element without necessarily requiring or involving any physical or logical relationship or sequence between such subjects or elements. Wherever possible, the same reference numerals will be used throughout the drawings to refer to the same parts.

Additionally, the terms “comprises,” “includes,” and “has” described herein should be interpreted not to exclude other elements but to further include such other elements, since the corresponding elements may be inherent unless mentioned otherwise. In addition, the term “corresponding to” described herein may encompass at least one of the meanings of “facing” and “overlapping.”

Hereinafter, a camera device and an optical instrument including the same according to embodiments will be described with reference to the accompanying drawings. For convenience of description, a camera device according to an embodiment will be described using the Cartesian coordinate system (x, y, z), but the embodiments are not limited thereto, and may be described using other coordinate systems. In the respective drawings, the X-axis and the Y-axis may be directions perpendicular to the Z-axis, which is an optical-axis (OA) direction. In addition, the Z-axis direction, which is the optical-axis (OA) direction, may be referred to as a “first direction”, the X-axis direction may be referred to as a “second direction”, and the Y-axis direction may be referred to as a “third direction”. In addition, the Y-axis may be referred to as a “first axis”, and the Y-axis direction may be referred to as a “first-axis direction”. The X-axis may be referred to as a “second axis”, and the X-axis direction may be referred to as a “second-axis direction”. For example, the optical axis direction is a direction of the optical axis or a direction parallel to the optical axis.

In addition, hereinafter, the “terminal” may alternatively be referred to as a pad, an electrode, or a conductive layer.

In addition, hereinafter, the “code value” may alternatively be referred to as data or a digital value.

In addition, in the embodiments, when two components are coupled to each other through coupling between a protrusion and a hole, one of the components may include a coupling protrusion (or coupling hole), and the remaining one of the components may include a coupling hole (or coupling protrusion) corresponding thereto.

A camera device according to an embodiment may perform a hand-shake compensation function, an autofocus function, and a zoom function. The “hand-shake compensation function” may be a function of moving a lens in a direction perpendicular to the optical-axial direction or tilting the lens with respect to the optical axis so as to cancel vibration (or motion) caused by shaking of the user's hand. In addition, the “autofocus function” may be a function of automatically focusing on a subject by moving the lens in the optical-axis direction according to a distance to the subject so that an image sensor obtains a clear image of the subject. The “zoom function” may be a function of photographing a subject while increasing or decreasing the magnification of a distant subject through a zoom lens.

Hereinafter, the “camera device” may alternatively be referred to as a “camera”, a “camera module”, an “image-capturing device”, or a “photographing device”.

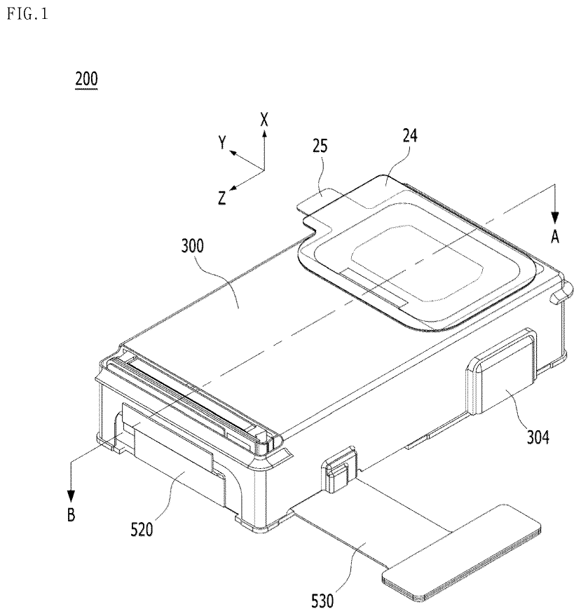

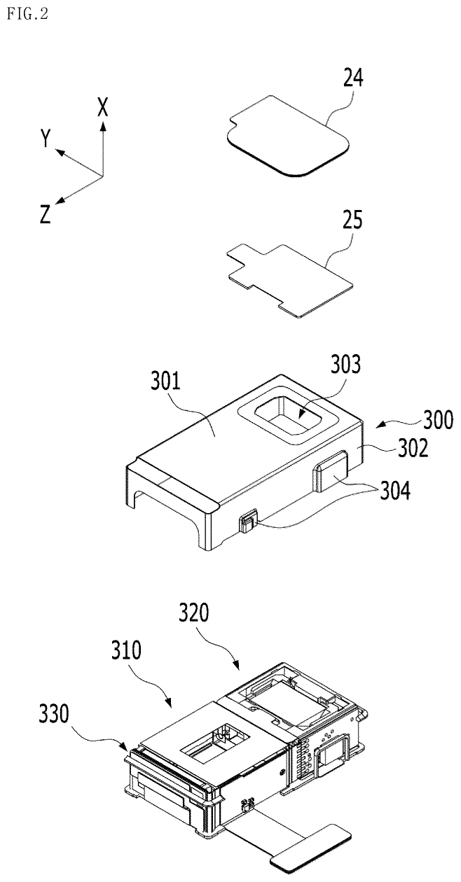

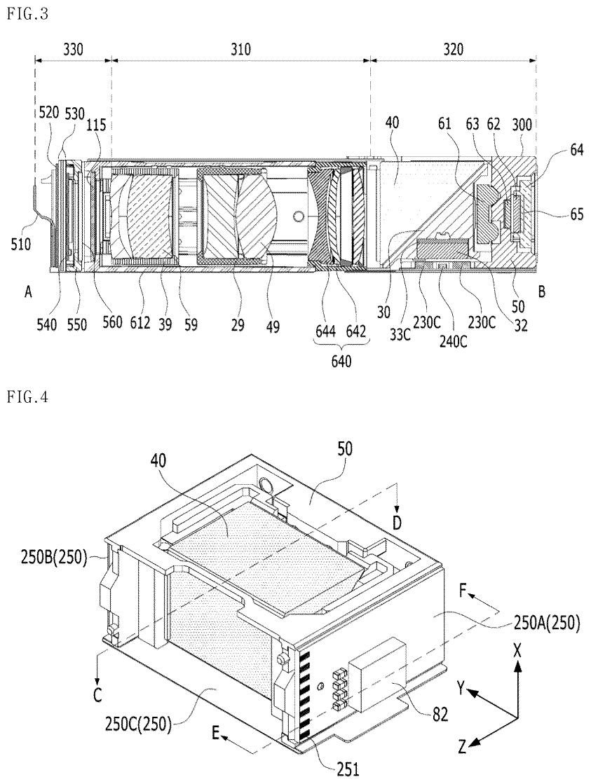

FIG. 1 is a perspective view of a camera device 200 according to an embodiment, FIG. 2 is an exploded perspective view of the camera device 200 in FIG. 1, and FIG. 3 is a cross-sectional view of the camera device taken along line AB in FIG. 1.

Referring to FIGS. 1 to 3, the camera device 200 may include a first actuator 310, a second actuator 320, and an image sensing unit 330.

The second actuator 320 may move an optical member 40, thereby performing optical image stabilizer (OIS) operation to implement hand-shake compensation, and may alternatively be referred to as a “second driving unit” or an “OIS driving unit”.

The second actuator 320 may change the path of light. For example, the second actuator 320 may include an optical member 40 configured to change the path of light. The second actuator 320 may alternatively be referred to as an optical path changer.

The first actuator 310 may move lens assemblies 312 and 313 in the optical-axis direction, thereby performing an autofocus function and/or a zoom function. The first actuator 310 may alternatively be referred to as a “first driving unit” or an “AF and zoom driving unit”. The first actuator 310 may be referred to as a “second actuator”, and the second actuator 320 may be referred to as a “first actuator”.

In an example, the first actuator 310 may be disposed on the rear end of the second actuator 320 and may be coupled to the second actuator 320.

The image sensing unit 330 may receive and detect light that has passed through the optical member 40 of the second actuator 320 and the lens assemblies 640, 622, and 624 of the first actuator 310, and may convert the detected light into an electrical signal.

The camera device 200 may further include a cover member 300. The cover member 300 may be formed in a shape of a box including an open lower portion, an upper plate 301, and a side plate 302. The cover member 300 of the camera device 200 may accommodate the first actuator 310, the second actuator 320, and the image sensing unit 330.

The upper plate 301 of the cover member 300 may include an opening 303 or a hole formed therein so as to expose an incidence surface of the optical member 40.

In addition, the camera device 200 may further include a bracket in order to accommodate the first actuator 310, the second actuator 320, and the image sensing unit 330. The bracket may include a hole or a through-hole formed therein so as to accommodate the first actuator 310, the second actuator 320, and the image sensing unit 330. At least one opening may be formed in a side portion or a side surface of the bracket.

The side plate 302 of the cover member 300 may include at least one protrusion 304 formed thereon so as to be coupled to the at least one opening in the bracket. The at least one protrusion 304 may protrude from the side plate 302 in a direction (e.g., Y-axis direction) perpendicular to the optical axis.

The cover member 300 may be formed as a metal plate, without being limited thereto, and may be formed of plastic or resin. Further, the cover member 300 may be made of a material that blocks electromagnetic waves.

The camera device 200 may further include a protective film 24 disposed on the upper plate 301 of the cover member 300 so as to cover the opening 303 in the cover member 300. The protective film 24 may be formed of a light transmissive material, may prevent foreign substances from entering the camera device 200, and may protect the optical member 40 from impact. In addition, the camera device 200 may further include a protective tape 25 disposed between the protective film 24 and the upper plate 301 in order to attach the protective film 24 to the upper plate 301. For example, the protective tape 25 may be formed of a light transmissive material.

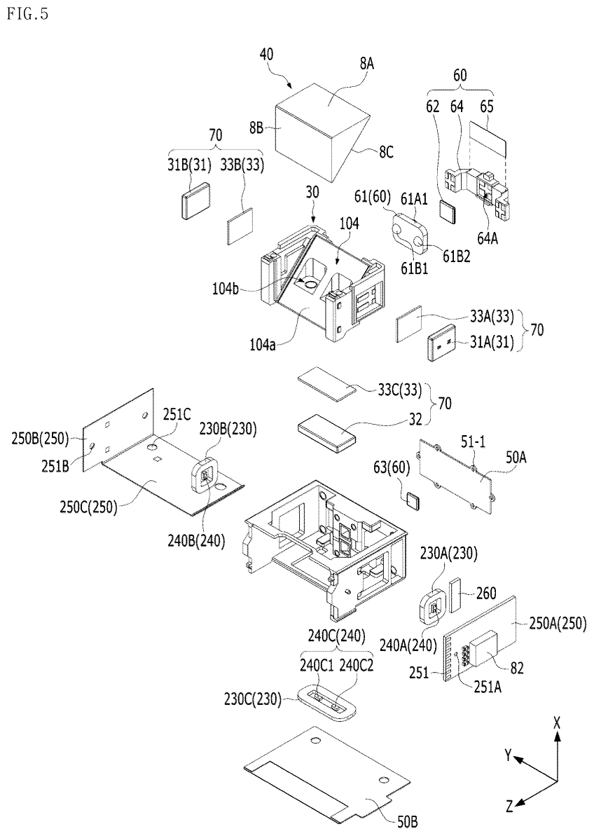

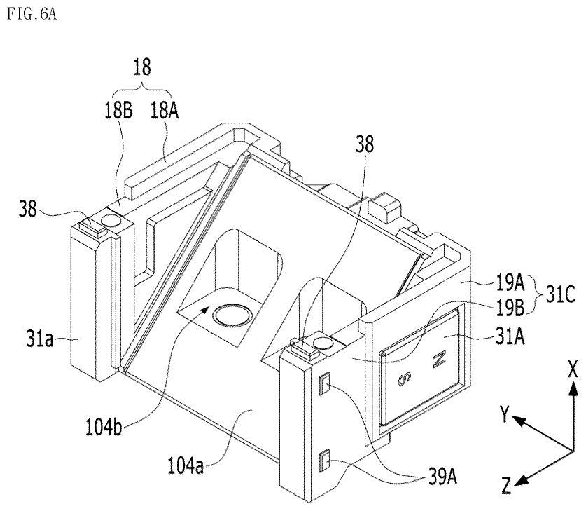

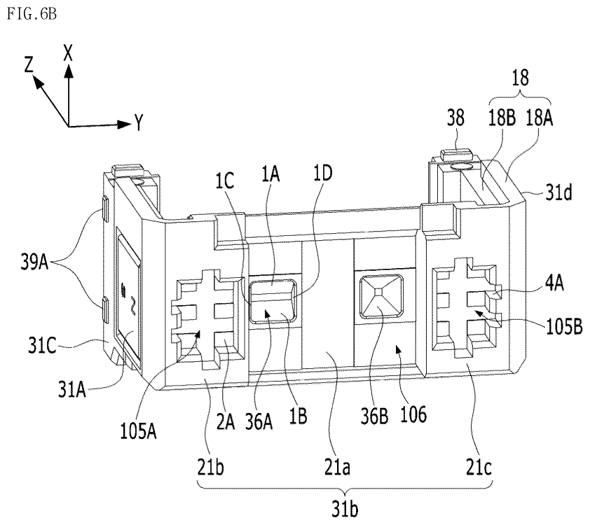

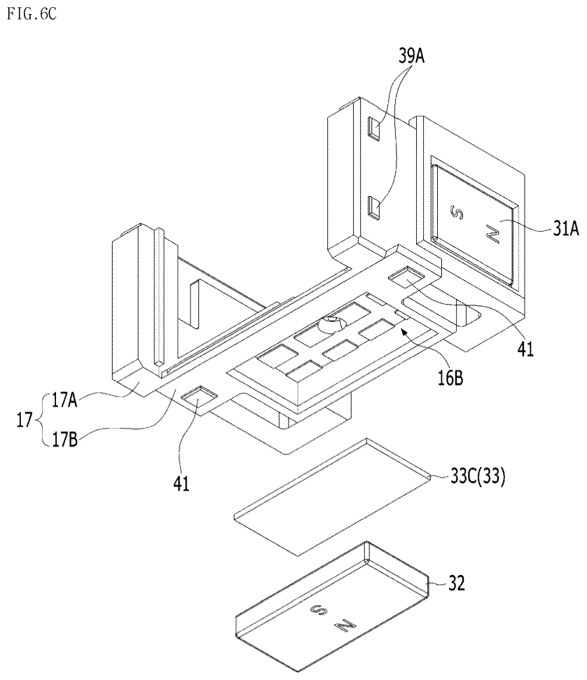

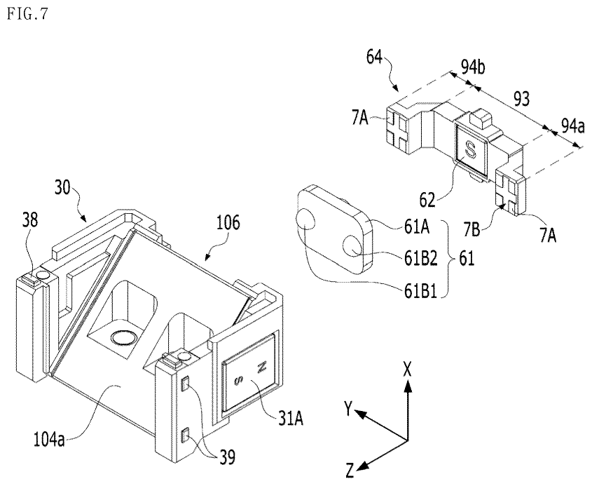

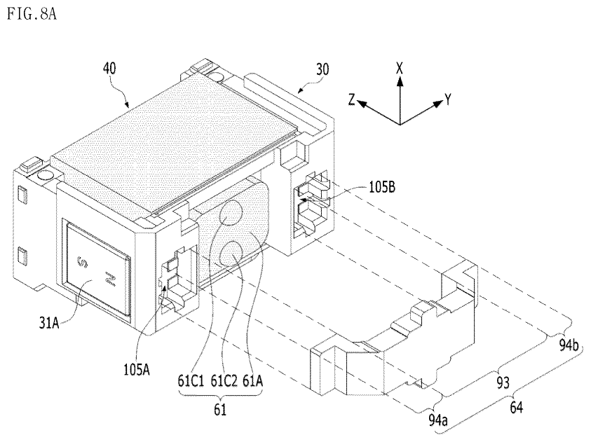

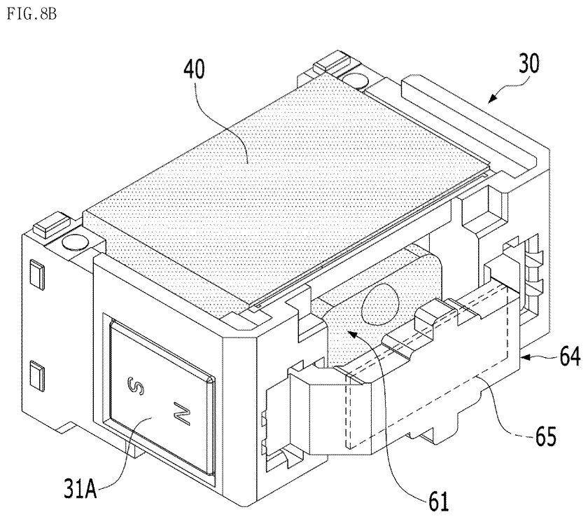

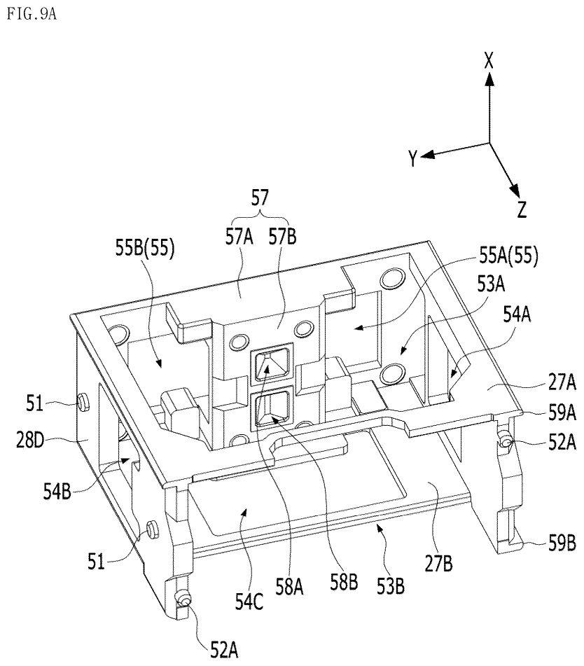

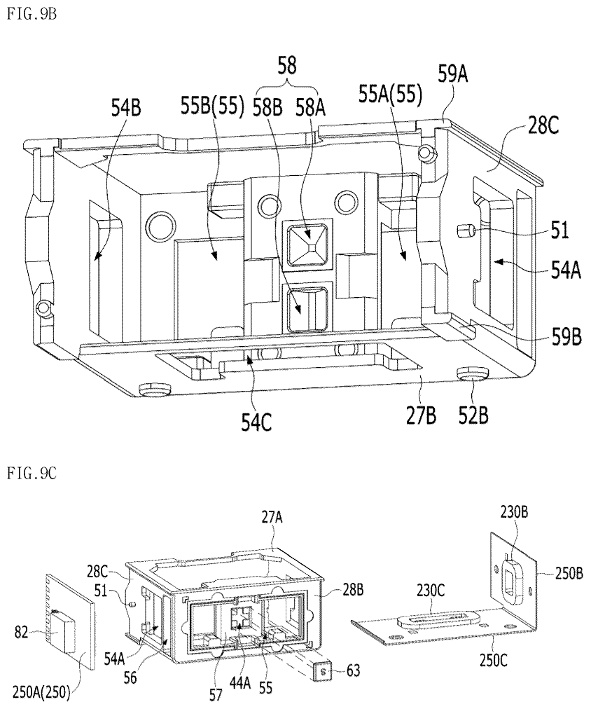

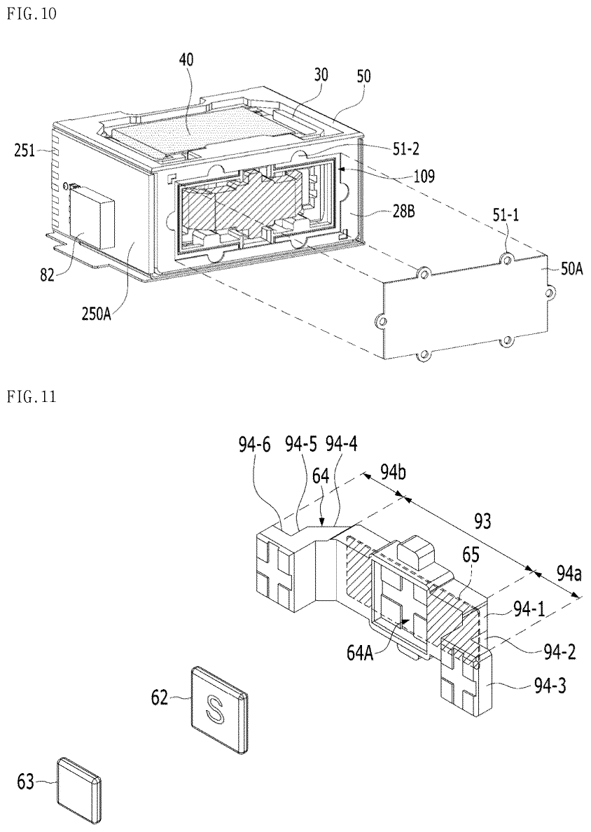

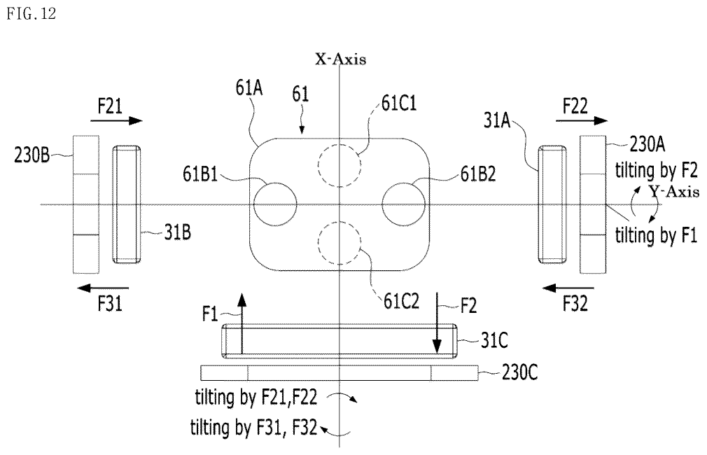

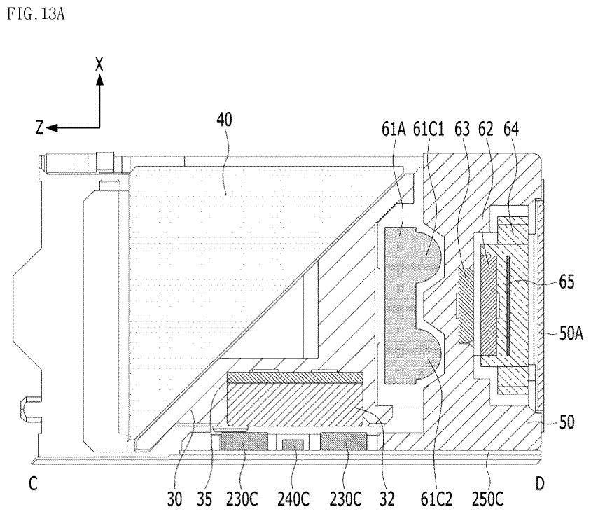

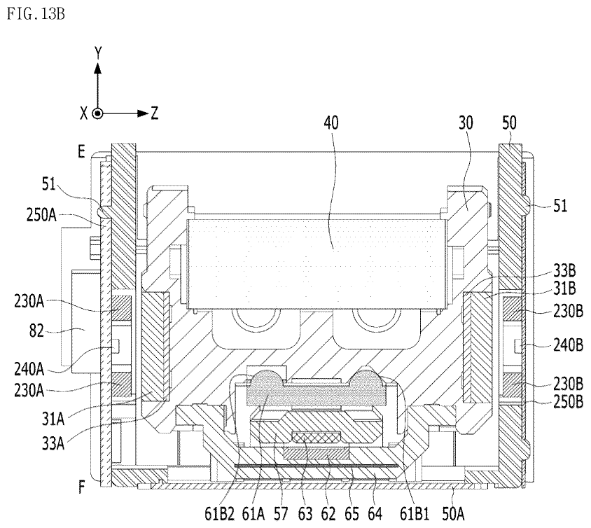

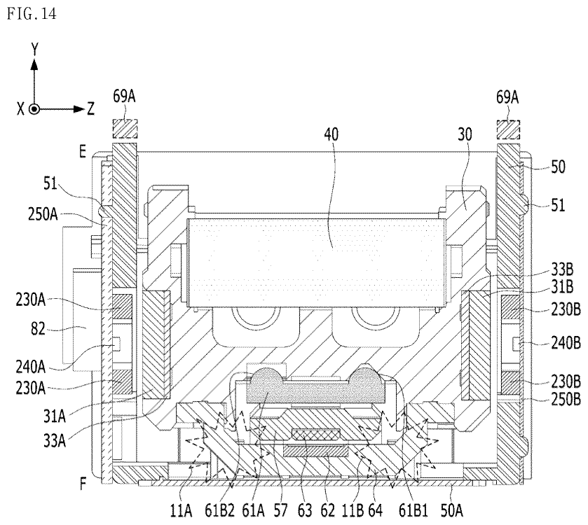

FIG. 4 is a perspective view of the second actuator 320 shown in FIG. 1, FIG. 5 is an exploded perspective view of the second actuator 320, FIG. 6A is a front perspective view of a holder 30 in FIG. 5, FIG. 6B is a rear perspective view of the holder 30, FIG. 6C is a lower perspective view of the holder 30, FIG. 7 is an exploded perspective view of the holder 30, a driving plate 61, and a magnetic body support part 64, FIG. 8A is an exploded perspective view of the holder 30, to which the optical member 40, the driving plate 61, and an OIS magnet 31 are coupled, and the magnetic body support part 64, FIG. 8B is a coupled perspective view of the optical member 40, the driving plate 61, the OIS magnet 31, and the magnetic body support part 64, FIG. 9A is a first perspective view of a first housing 50, FIG. 9B is a second perspective view of the first housing 50, FIG. 9C is an exploded perspective view of the first housing 50 and a second magnetic body 63, FIG. 10 is a perspective view of the first housing 50, the holder 30, the optical member 40, a first circuit board 250A, and a cover plate 51A. FIG. 11 is a perspective view of the first magnetic body, the second magnetic body, the plate, and the magnetic body support part. FIG. 12 is a view for explaining electromagnetic force and movement of the driving plate according to interaction between first to third OIS magnets 31A, 31B, and 32 and first to third coil units 230A to 230C, FIG. 13A is a cross-sectional view of the second actuator 320 taken along line CD in FIG. 4, and FIG. 13B is a cross-sectional view of the second actuator 320 taken along line EF in FIG. 4.

Referring to FIGS. 4 to 13B, the second actuator 320 may include an optical member 40 configured to change an optical path so that light that has passed through the opening 303 in the cover member 300 is introduced into the first actuator 310 and a second driving part 70 configured to rotate the optical member 40 at a predetermined angle in a direction (e.g., X-axis direction or Y-axis direction) perpendicular to the optical-axis direction (e.g., Z-axis direction).

The optical member 40 may include a reflective portion capable of changing the travel direction of light. For example, the optical member 40 may be a prism that reflects light. However, the disclosure is not limited thereto. In another embodiment, the optical member 40 may be a mirror.

The optical member 40 may disposed on the holder 30. The optical member 40 may change the optical path of incident light to the optical axis parallel to the central axis Z of the lens unit to convert the incident light into parallel light, and the parallel light may reach an image sensor 540 through the first lens assembly 640, the second lens assembly 622, and the third lens assembly 624.

Referring to FIG. 5, in an example, the optical member 40 may include an incident surface 8A and an emission surface 8B, and may reflect light incident on the incident surface 81 and emit the light through the emission surface 8B. For example, the optical member 40 may be a right-angled prism including an incident surface 8A, a reflective surface 8C, and an emission surface 8B. For example, an internal angle between the incident surface 8A and the emission surface 8B may be a right angle.

In addition, for example, each of a first internal angle between the incident surface 8A and the reflective surface 8C and a second internal angle between the emission surface 8B and the reflective surface 8C may be 30 degrees to 60 degrees. For example, each of the first internal angle and the second internal angle may be 45 degrees. However, the disclosure is not limited thereto. In addition, due to change in the optical path by the optical member 40, the thickness of the camera device 200 in a direction perpendicular to the incident surface 8A of the optical member 40 may be reduced, and accordingly, the thickness of a mobile device or a terminal 200A in which the camera device 200 is mounted may be reduced.

In an example, the second actuator 320 may include a first housing 50, a holder 30 disposed in the first housing 50, an optical member 40 disposed in the holder 30, a support part 60 disposed between the holder 30 and the housing 50. The second actuator may include a second driving part 70.

Referring to FIGS. 5 and 6A to 6C, the holder 30 may include a seating part 104 on which the optical member 40 is disposed or mounted. The seating part 104 may have a recess shape and may include a mounting surface 104a (or seating surface) on which the reflective surface 8C of the optical member 40 is disposed. For example, the mounting surface 104a may be an inclined surface inclined with respect to the optical-axis direction.

In an example, an adhesive for attachment of the optical member 40 may be disposed on the mounting surface 104a of the holder 30, and at least one recess 104b for receiving the adhesive may be formed in the mounting surface 104a.

In an example, the holder 30 may include a first opening exposing the incident surface 8A of the optical member 40 and a second opening exposing the emission surface 8B of the optical member 40. In an example, the first opening may be formed in the upper side of the holder 30, and the second opening may be formed in one side surface 31a (front outer surface) of the holder 30 facing the lens assembly (e.g., 640) of the first actuator 310. The emission surface 8B of the optical member 40 mounted in the holder 30 may be disposed so as to face the lens assembly (e.g., 640) of the first actuator 310.

Referring to FIG. 6A, the upper surface 18 of the holder 30 may include a first surface 18A and a second surface 18B having a height difference from the first surface 18A in the second direction (e.g., X-axis direction). The first surface 18A may be located adjacent to or contiguous with a rear outer surface 31b of the holder 30, and the second surface 18B may be located adjacent to or contiguous with a front outer surface 31a of the holder 30. The second surface 18B may be located below the first surface 18A. In an example, the second surface 18B may be located closer to the lower surface 19 of the holder 30 than the first surface 18A.

Since the second surface 18B has a height difference from the first surface 18A, when the holder 30 is tilted in the second direction (e.g., X-axis direction) or rotated at a predetermined angle, spatial interference between the holder 30 and the first housing 50 may be prevented.

In an example, at least one stopper 38 may be formed on the upper surface (e.g., second surface 18B) of the holder 30. The stopper 38 may be a protrusion or a protruding portion that protrudes upward from the upper surface (e.g., second surface 18B) of the holder 30. In an example, the stopper 38 may be formed on the upper surface of each of first and second side portions of the holder 30. Tilt or rotation of the holder 30 in the second direction may be restricted by the stopper 38. In an example, the height of the upper surface of the stopper 38 may be lower than or equal to the height of the first surface 18A.

The holder 30 may include first and second side portions (or outer side surfaces) 31c and 31d facing each other or opposite to each other. In an example, the seating part 104 may be located between two side portions 31c and 31d of the holder 30. In an example, the two side portions 31c and 31d may be located opposite each other or located so as to face each other in the third direction (e.g., Y-axis direction).

For example, a front outer surface 31a of the holder 30 is referred to an outer surface of a first side of the holder 30, and a rear outer surface 31b of the holder 30 is referred to an outer surface of a second side of the holder 30. The side portion 31c of the holder 30 is referred to a third side of the holder 30, and the side portion 31d of the holder 30 is referred to a fourth side portion 31d of the holder 30.

Each of the third and fourth side portions 31c and 31d of the holder 30 may include a first outer side surface 19A and a second outer side surface 19B having a height difference from the first outer side surface 19A in the third direction (e.g., Y-axis direction). The first outer side surface 19A may be located adjacent to or contiguous with the rear outer surface 31b of the holder 30, and the second outer side surface 19B may be located adjacent to or contiguous with the front outer surface 31a of the holder 30. The second outer side surface 19B may be located closer to the inner side surface of the holder 30 than the first outer side surface 19A.

Since the second outer side surface 19B of the holder 30 has a height difference from the first outer side surface 19A, when the holder 30 is tilted in the third direction (e.g., Y-axis direction) or rotated at a predetermined angle, spatial interference between the holder 30 and the first housing 50 may be prevented.

In an example, at least one stopper 39A may be formed on the third and fourth side portions (e.g., second outer side surface 19B) of the holder 30. The stopper 39A may be a protrusion or a protruding portion that protrudes from the outer side surface (e.g., second outer side surface 19B) of each of the third and fourth side portions 31c and 31d of the holder 30. Tilt or rotation of the holder 30 in the third direction may be restricted by the stopper 39A. In an example, the protruding height of the stopper 39A from the second outer side surface 19B may be less than or equal to the height difference between the first outer side surface 19A and the second outer side surface 19B.

Referring to FIG. 6C, the lower surface 17 of the holder 30 may include a first surface 17A and a second surface 17B having a height difference from the first surface 17A in the second direction (e.g., X-axis direction). The first surface 17A may be located adjacent to or contiguous with the front outer surface 31a of the holder 30, and the second surface 17B may be located adjacent to or contiguous with the rear outer surface 31b of the holder 30. The first surface 17A may be located below the second surface 17B. In an example, the second surface 17B may be located closer to the upper surface 18 of the holder 30 than the first surface 17A.

Since the second surface 17B of the lower surface 17 of the holder 30 has a height difference from the first surface 17A, when the holder 30 is tilted in the second direction (e.g., X-axis direction) or rotated at a predetermined angle, spatial interference between the holder 30 and a second OIS coil 230C may be prevented.

In an example, at least one stopper 41 may be formed on the lower surface (e.g., second surface 17B) of the holder 30. The stopper 41 may be a protrusion or a protruding portion that protrudes downward from the lower surface (e.g., second surface 17B) of the holder 30. Tilt or rotation of the holder 30 in the second direction may be restricted by the stopper 41. In an example, the protruding length of the stopper 38 from the second surface 17B may be less than or equal to the height difference between the first surface 17A and the second surface 17B of the lower surface 17 of the holder 30.

The holder 30 may include a first seating recess 16A formed therein so as to allow a first OIS magnet 31 to be disposed or seated therein and a second seating recess 16B formed therein so as to allow a second OIS magnet 32 to be disposed or seated therein.

In an example, the first seating recess 16A may be formed in the outer side surface (e.g., first outer side surface 19A) of each of the third and fourth side portions 31c and 31d of the holder 30. For example, the first seating recess 16A may be formed in a shape of a recess depressed in the first outer side surface 19A of each of the third and fourth side portions 31c and 31d of the holder 30.

In an example, the second seating recess 16B may be formed in the lower surface 17 (e.g., second surface 16B) of the holder 30. For example, the second seating recess 16B may be formed in a shape of a recess depressed in the lower surface 17 (e.g., second surface 16B) of the holder 30.

Referring to FIG. 6B, the rear outer surface 31b of the holder 30 may include a first surface 21a, a second surface 21b that is adjacent to or contiguous with the third side portion 31c, and a third surface 21c that is adjacent to or contiguous with the fourth side portion 31d.

When viewed from rear, the first surface 21a may be disposed in the center, the second surface 21b may be disposed on the left of the first surface 21a, and the third surface 21c may be disposed on the right of the first surface 21a.

Each of the second surface 21b and the third surface 21c may have a height difference from the first surface 21a in the first direction (e.g., Z-axis direction). In an example, the first surface 21a may be located closer to the inner side surface of the holder 30 than each of the second surface 21b and the third surface 21c. In an example, the second surface 21b and the third surface 21c may be located on the same plane. Alternatively, in another example, the height difference between the first surface 21a and the second surface 21b may be identical to the height difference between the first surface 21a and the third surface 21c. However, the disclosure is not limited thereto. In another embodiment, the two height differences may be different from each other.

In an example, a recess 106 in which a driving plate 61 is seated or accommodated may be formed in the rear outer surface 31b of the second side portion of the holder 30. For example, the recess 106 may be disposed in the center of the rear outer surface 31b, and may be formed so as to be depressed in the rear outer surface 31b.

The holder 30 may include at least two recesses 36A and 36B formed in the first surface 21a of the rear outer surface 31b thereof so as to correspond to at least two front protrusions 61B1 and 61B2 of the driving plate 61. In an example, the at least two recesses 36A and 36B in the holder 30 may be arranged so as to be spaced apart from each other in the third direction, and may be formed in the bottom surface of the recess 106.

In an example, the holder 30 may include a second recess 36B formed in the first surface 21a of the rear outer surface 31b thereof and a first recess 36A spaced apart from the second recess 36B and located on the right. In another embodiment, the first recess may be located on the right.

In an example, the first recess 36A may include a bottom surface and a plurality of side surfaces 1A to 1D. The area of at least one of the plurality of side surfaces 1A to 1D of the first recess 36A may be different from the area of at least another one of the plurality of side surfaces 1A to 1D of the first recess 36B.

In an example, two side surfaces 1C and 1D of the first recess 36A facing each other in the third direction may be symmetrical to each other and may have the same area. In addition, two side surfaces 1A and 1B of the first recess 36A facing each other in the second direction may be symmetrical to each other and may have the same area.

The first area of each of the side surfaces 1C and 1D of the first recess 36A facing each other in the third direction may be different from the second area of each of the side surfaces 1A and 1D of the first recess 36A facing each other in the second direction. For example, the first area may be smaller than the second area. In another embodiment, the first area may be larger than the second area. For example, the bottom surface of the first recess 36A may have a rectangular shape or an elliptical shape. However, the disclosure is not limited thereto.

In an example, the second recess 36B may include a bottom surface and a plurality of side surfaces. The plurality of side surfaces of the second recess 36B may have the same shape. In FIG. 6B, the number of side surfaces of the second recess 36B is four. However, the disclosure is not limited thereto. In another embodiment, the number of side surfaces of the second recess may be five or more.

In an example, the plurality of side surfaces of the second recess 36B may have the same area. The plurality of side surfaces of the second recess 36B may be symmetrical to each other in the second direction and the third direction. For example, the bottom surface of the second recess 36B may have a square shape or a circular shape. However, the disclosure is not limited thereto.

If both the first and second recesses in the holder 30 have the shape of the second recess 36B shown in FIG. 6B, manufacturing tolerances may occur in the first and second recesses in the holder 30 and/or the front protrusions of the driving plate 61, with the result that the front protrusions of the driving plate 61 may not be properly or stably coupled to the first and second recesses in the holder 30.

In the embodiment, since the second recess 36B is formed to have a different shape from the first recess 36A, a sufficient coupling margin may be ensured between the front protrusions 61B1 and 61B2 of the driving plate 61 and the first and second recesses 36A and 36B in the holder 30. That is, even if the aforementioned manufacturing tolerances occur, the front protrusions 61B1 and 61B2 of the driving plate 61 may be properly or stably coupled to the first and second recesses 36A and 36B in the holder 30 due to the first recess 36A, and OIS operation may be stably implemented.

But, in another embodiment the first and second recesses is formed to have the same shape. In an example, each of the first and second recesses of the holder 30 may be formed to have a shape of the first recess 36A or a shape of the second recess 36B in FIG. 6B.

A protruding portion or a stepped portion may be formed around the first recess 36A and the second recess 36B. The protruding portion may be formed so as to protrude from the first surface 21a of the rear outer surface 31b. A lubricant may be disposed between the front protrusions 61B1 and 61B2 and the first and second recesses s 36A and 36B, and the protruding portion formed around the first and second recesses may prevent the lubricant from overflowing.

The holder 30 may include at least one coupling recess 105A or 105B formed in the rear outer surface 31b thereof so as to be coupled to the magnetic body support part 64.

In an example, the holder 30 may include a first coupling recess 105A formed in the second surface 21b of the rear outer surface 31b thereof and a second coupling recess 105B formed in the third surface 21c of the rear outer surface 31b thereof.

In an example, at least one protrusion 2A (or recess) may be formed on at least one of the side surface or the bottom surface of each of the first and second coupling recesses 105A and 105B. In an example, the at least one protrusion 2A may correspond to at least one recess 7B in the magnetic body support part 64 or may be formed at a position corresponding to the at least one recess 7B.

Recesses 4A in which an adhesive is disposed may be formed in at least one of the side surface or the bottom surface of each of the first and second coupling recesses 105A and 105B. The recesses 4A may increase an adhesion area between the adhesive and the magnetic body support part 64 and may enhance coupling between the holder 30 and the magnetic body support part 64.

The holder 30 may include at least one stopper (not shown) formed on the rear outer surface 31b. In an example, the stopper may be formed in a shape of a protrusion or a protruding portion that protrudes from each of the second surface 21b and the third surface 21c of the rear outer surface 31b.

The first housing 50 may be disposed in the cover member 300. In an example, an adhesive or a shield member may be disposed between the first housing 50 and the cover member 300, and the first housing 50 may be coupled or fixed to the cover member 300. The holder 30 may be disposed in the first housing 50. The first housing 50 may accommodate the holder 30 therein, and may expose the incident surface 8A and the emission surface 8B of the optical member 40 disposed in the holder 30.

Referring to FIGS. 9A to 9C, in an example, the first housing 50 may include a first opening 53A (or first hole) formed therein so as to expose the incident surface 8A of the optical member 40 and a second opening 53B (or second hole) formed therein so as to expose the emission surface 8B of the optical member 40.

The first housing 50 may include an upper portion 27A, a lower portion 27B, and a side portion disposed between the upper portion 27A and the lower portion 27B. In an example, the side portion of the first housing 50 includes a plurality of side portions 28A to 28D. The upper portion 27A and the lower portion 27B may face each other or may be located opposite each other in the second direction (e.g., X-axis direction).

In an example, the first housing 50 may include a first side portion 28A, a second side portion 28B, a third side portion 28C, and a fourth side portion 28D.

In an example, the first side portion 28A of the first housing 50 may be disposed so as to oppose or face the lens assembly (e.g., 640) of the first actuator 310. The first opening 53A may be formed in the upper portion 27A, and the second opening 53B may be formed in the first side portion 28A.

The second side portion 28B may face the first side portion 28A or may be located opposite the first side portion 28A in the first direction. The third side portion 28C and the fourth side portion 28D may be disposed between the first side portion 28A and the second side portion 28B, and may face each other or may be located opposite each other in the third direction. In an example, the third side portion 28C may connect one end of the first side portion 28A to one end of the second side portion 28B, and the fourth side portion 28D may connect the other end of the first side portion 28A to the other end of the second side portion 28B.

In an example, the first housing 50 may include a first hole 54A formed in the third side portion 28C thereof so as to allow a first OIS coil unit 230A to be seated or disposed therein, a second hole 54B formed in the fourth side portion thereof so as to allow a second OIS coil unit 230B to be seated or disposed therein, and a third hole 54C formed in the lower portion 27B thereof so as to allow a third OIS coil unit 230C to be seated or disposed therein. For example, each of the first to third holes 54A to 54C may have a through-hole shape. However, the disclosure is not limited thereto. In another embodiment, each of the first to third holes may have a recess shape.

In addition, a recess 56 (or through-hole) in which a second driver 260 is disposed or seated may be formed in the third side portion 28C (or fourth side portion 28D) of the first housing 50. In an example, the recess 56 may be formed so as to be spaced apart from the first hole 54A.

The first housing 50 may include at least one coupling protrusion 51 formed on at least one of the third side portion 28C or the fourth side portion 28D. In an example, the coupling protrusion 51 may protrude from the outer side surface of each of the third side portion 28C and the fourth side portion 28D. In addition, the first housing 50 may include at least one coupling protrusion 52A formed on the first side portion 28A. In an example, the coupling protrusion 52A may protrude from the outer side surface of the first side portion 28A.

In addition, the first housing 50 may include at least one coupling protrusion 52B formed on the lower portion 28B. In an example, the coupling protrusion 52B may be formed so as to protrude from the outer surface of the lower portion 28B.

Guide protrusions 59A and 59B for guiding a first circuit board 250A may be formed on at least one of the upper end or the lower end of the third side portion 28C of the first housing 50. In addition, a guide protrusion for guiding a second circuit board 250B may be formed on at least one of the upper end or the lower end of the fourth side portion 28D of the first housing 50.

The first housing 50 may include at least two recesses 58A and 58B formed in the second side portion 28B thereof so as to correspond to at least two rear protrusions 61C1 and 61C2 of the driving plate 61. In an example, the at least two recesses 58A and 58B in the first housing 50 may be arranged so as to be spaced apart from each other in the second direction.

A protruding portion or a stepped portion may be formed around the at least two recesses 58A and 58B, and a lubricant may be disposed between the rear protrusions 61C1, 61C2 and the recesses 58A and 58B. The description of the protruding portion of the holder 30 may be equally or similarly applied thereto.

In an example, the first housing 50 may include a protruding portion 57 protruding from the inner side surface of the second side portion 28B toward the first side portion 28A, and a first recess 58A and a second recess 58B that correspond to, face, or overlap the rear protrusions 61C1 and 61C2 of the driving plate 61 may be formed in the protruding portion 57. In another embodiment, the protrusion 57 of the first housing 50 may be not included in the first housing 50, and the first recess 58A and the second recess 58B may be formed at the second side portion 28B (For example, an inner side surface) of the first housing 50.

In an example, the protruding portion 57 may include a first portion 57A protruding from the inner side surface of the second side portion 28B and a second portion 57B connecting the first portion 57A to the lower portion 27B of the first housing 50.

The first recess 58A and the second recess 58B in the first housing 50 may be formed in the inner side surface (or front surface) of the second portion 57B of the protruding portion 57.

In addition, a recess 44A in which a second magnetic body 63 is disposed or seated may be formed in the rear surface of the protruding portion 57.

The description of the shapes of the first and second recesses 36A and 36B in the holder 30 may be equally or similarly applied to the first and second recesses 58A and 58B in the first housing 50.

In the embodiment, since the second recess 58B in the first housing 50 is formed to have a different shape from the first recess 58A, a sufficient coupling margin may be ensured between the rear protrusions 61C1 and 61C2 of the driving plate 61 and the first and second recesses 58A and 58B in the housing 50. That is, even if manufacturing tolerances occur in the rear protrusions of the driving plate 61 and the first and second recesses in the first housing, the rear protrusions 61C1 and 61C2 of the driving plate 61 may be properly or stably coupled to the first and second recesses 58A and 58B in the first housing 50 due to the second recess 58B, and accordingly, OIS operation may be stably implemented. In another embodiment, the first and second recesses 36Am 36B may have the same shape.

In FIG. 9B, when the first housing 50 is viewed from the front, the first recess 58A is located above the second recess 58B. However, the disclosure is not limited thereto. In another embodiment, the first recess 58A may be located below the second recess 58B.

In an example, an opening 55 in which the magnetic body support part 64 is disposed may be formed in the second side portion 28B of the first housing 50. In an example, the opening may be a through-hole penetrating the second side portion 28B of the first housing 50.

In addition, at least one through-hole may be formed in the second side portion 28B of the first housing 50. In an example, a first through-hole 55A and a second through-hole 55B may be formed in the second side portion 28B of the first housing 50.

As shown in FIG. 9C, when viewed from the rear of the first housing 50, the first through-hole 55A may be located on one side (e.g., right side) of the protruding portion 57 of the first housing 50, and the second through-hole 55B may be located on the other side (e.g., left side) of the protruding portion 57. A portion of the magnetic body support part 64 may pass through the first through-hole 55A of the first housing 50, and another portion of the magnetic body support par 64 may pass through the second through-hole 55B of the first housing 50.

Next, the support part 60 will be described.

The support part 60 may be disposed between the holder 30 and the first housing 50, and may support the holder 30 with respect to the first housing 50. The support part 60 may include a driving plate 61 disposed between the holder 30 and the first housing 50. The driving plate 61 may alternatively be expressed as “mover,” “mover plate,” “driving board,” “plate,” “moving plate,” or “support plate.”

The driving plate may be disposed between the holder 30 and the first housing 50. In an example, the driving plate may be disposed between the second side portion of the holder 30 and the first housing 50. In an example, the driving plate may be disposed between the second side portion of the holder 30 and the second side portion 28B of the first housing 50.

The driving plate 61 may include at least two front protrusions 61B1 and 61B2 that are coupled to the holder 30 and at least two rear protrusions 61C1 and 61C2 that are coupled to the first housing 50.

In an example, the at least two front protrusions 61B1 and 61B2 may be arranged so as to be spaced apart from each other in the third direction. Each of the front protrusions 61B1 and 61B2 may be disposed in a corresponding one of the first and second recesses 36A and 36B in the holder 30. In another embodiment, the front protrusions may be arranged so as to be spaced apart from each other in the second direction.

In an example, the at least two rear protrusions 61C1 and 61C2 may be arranged so as to be spaced apart from each other in the second direction. Each of the rear protrusions 61C1 and 61C2 may be disposed in a corresponding one of the first and second recesses 58A and 58B in the first housing 50. In another embodiment, the rear protrusions may be arranged so as to be spaced apart from each other in the third direction.

In an example, the driving plate 61 may include a body 61A disposed in the recess 106 in the holder 30, front protrusions 61B1 and 61B2 protruding from the front surface of the body 61A, and rear protrusions 61C1 and 61C2 protruding from the rear surface of the body 61A. In an example, the front protrusions 61B1 and 61B2 and the rear protrusions 61C1 and 61C2 may protrude in opposite directions.

For example, each of the front protrusions 61B1 and 61B2 may have a curved shape, a hemispherical shape, a dome shape, or a polyhedral shape. However, the disclosure is not limited thereto. Also, for example, each of the rear protrusions 61C1 and 61C2 may have a curved shape, a hemispherical shape, a dome shape, or a polyhedral shape. However, the disclosure is not limited thereto.

In another embodiment, front recesses may be formed in the front surface of the driving plate instead of the front protrusions, and protrusions for engagement with the front recesses of the driving plate may be formed at the holder instead of the first and second recesses 36A and 36B.

In another embodiment, rear recesses may be formed in the rear surface of the driving plate instead of the rear protrusions, and protrusions for engagement with the rear recesses in the driving plate may be formed at the first housing instead of the first and second holes 58A and 58B.

For example, the driving plate 61 may be made of an injection-molded material such as plastic or resin. In another embodiment, the driving plate 61 may be made of metal, e.g., SUS. Further, the driving plate 61 may be non-magnetic. In another embodiment, the driving plate may be magnetic.

The support part 60 may include a first magnetic body 62 disposed on or coupled to the holder 30, a second magnetic body 63 disposed on or coupled to the first housing 40, and a plate 65 disposed on or coupled to the holder 30.

In an example, the support part 60 may include a magnetic body support part 64, on which the first magnetic body 62 is disposed and which is coupled to the holder 30. The magnetic body support part 64 may be disposed to be spaced apart from the driving plate 61, and a portion of the magnetic body support part 64 may be coupled to the holder 30. In an example, the magnetic body support part 64 may pass through at least a portion of the first housing 50 to be coupled to the holder 30. The magnetic body support par 64 may be expressed as “support par”, “mover rigid” or “coupling part.”

Referring to FIGS. 7 to 10, the magnetic body support part 64 may extend from the body 93 and pass through the first housing 50 and be coupled to the holder 30. In an example, a portion of the magnetic body support part 64 may pass through the first housing 50 and be coupled to the second side portion of the holder 30. In an example, a portion of the magnetic body support part 64 may pass through the first housing 50 and be coupled to the rear outer surface 31b of the second side portion of the holder 30.

In an example, the magnetic body support part 64 may include a body 93, on which the first magnetic body 62 is disposed, a first extension portion 94a, which extends from one side of the body 93 and is coupled to the first coupling recess 105A in the holder 30 through the first through-hole 55A in the first housing 50, and a second extension portion 94b, which extends from the other side of the body 93 and is coupled to the second coupling recess 105B in the holder 30 through the second through-hole 55B in the first housing 50.

In an example, the first extension portion 94a and the second extension portion 94b may be left and right symmetrical with respect to the body 93. Also, for example, the first extension portion 94a may be bent from one side (or one end) of the body 93, and the second extension portion 94b may be bent from the other side (or other end) of the body 93. In an example, the first extension portion 94a may include a portion that is bent at least once from the one side (or one end) of the body 93. In an example, the second extension portion 94b may include a portion that is bent at least once from the other side (or other end) of the body 93.

In an example, the extension portions 94a and 94b may be bent in a direction toward the holder 30 or the optical member 40 with respect to the body 93. In an example, each of the first extension portion 94a and the second extension portion 94b includes three bent portions, but in other embodiments, it may include one or two or more bent portions.

Referring to FIG. 11, for example, the first extension portion 94a includes a first portion 94-1 bent from one side (or one end) of the body 93, and a second portion 94-2 bent from the first portion 94-1, and a third portion 94-3 bent from the second portion 94-2.

In an example, the second extension portion 94b includes a fourth portion 94-4 bent from the other side (or other end) of the body 93, and a fifth portion 94-5 bent from the fourth portion 94-4, and a sixth portion 94-6 bent from the fifth portion 94-5. The third portion 94-3 and the sixth portion 94-6 may be bent in opposite directions.

Each of the third portion 94-3 and the sixth portion 94-6 may be parallel to the body 93, but in another embodiment, each of the third portion 94-3 and the sixth portion 94-6 may not be parallel to the body 93.

Referring to FIGS. 5 and 11, in an example, a recess 64a in which the first magnetic body 62 is seated or disposed may be formed in the front surface of the body 93 of the magnetic body support part 64. In an example, the first magnetic body 62 may be coupled to the recess 64a in the magnetic body support part 64 by means of an adhesive. In addition, in an example, the extension portions 94a and 94b of the magnetic body support part 64 may be coupled to the coupling recesses 105A and 105B in the holder 30 by means of an adhesive.

Referring to FIG. 9C, the second magnetic body 63 may be disposed on the second side portion 28B of the first housing 50. In an example, the second magnetic body 63 may be disposed on the protruding portion 57 of the first housing 50. In an example, the second magnetic body 63 may be disposed in the recess 44A in the protruding portion 57 of the first housing 50. In an example, the second magnetic body 63 may be coupled to the recess 44A in the first housing 50 by means of an adhesive.

The magnetic body support part 64 is coupled to the holder 30, but may also be expressed as a part of the holder 30. In another embodiment, the magnetic body support part 64 may be expressed as an extension part extending from the holder 30. In another embodiment, the magnetic body support part 64 may be formed integrally with the holder 30.

Referring to FIGS. 13A and 13B, the first magnetic body 62 and the second magnetic body 63 may be disposed so as to face or overlap each other in the first direction.

The plate 65 may be disposed on holder 30. The plate 30 may be disposed outside the first magnetic body 62. For example, the plate 30 may be disposed behind a rear surface of the first magnetic body 62. The rear surface of the first magnetic body 62 may be an opposite surface of the front surface of the first magnetic body 62, which faces the rear surface of the second magnetic body 63. In an example, the first magnetic body 62 may be disposed between the second magnetic body 63 and the plate 30.

The plate 65 may be disposed on the magnetic body support part 64. The plate 65 may be disposed between the first magnetic body 62 and the cover plate 50A.

In an example, the plate 65 may be disposed to be spaced apart from the first magnetic body 62. In another embodiment, the plate 65 may be in contact with the first magnetic body 62. In an example, the front surface of the plate 65 may be disposed on the rear surface of the first magnetic body 62.

In an example, at least a portion of the plate 65 may be disposed to face or overlap the first magnetic body 62 in the first direction. Also, for example, at least a portion of the plate 65 may be disposed to face or overlap the second magnetic body 63 in the first direction. Also, for example, at least a portion of the plate 65 may be disposed to face or overlap the driving plate 61 in the first direction.

The second magnetic body 63 may be disposed between the first magnetic body 62 and the driving plate 61. In the embodiment, the driving plate 61 is not located between the first magnetic body 62 and the second magnetic body 63, and both the first magnetic body 62 and the second magnetic body 63 are disposed on one side of the driving plate 61. Therefore, a spacing distance between the first magnetic body 62 and the second magnetic body 63 may be reduced, and accordingly, magnetic force (e.g., repulsive force) between the first magnetic body 62 and the second magnetic body 63 may be increased.

The plate 65 may serve as a reinforcing member that reinforces the rigidity of the magnetic body support part 64. In addition, the plate 65 can concentrate the magnetic flux generated from the first magnetic body 62 to the second magnetic body 63. A magnetic force (e.g., repulsive force) between the first magnetic body 62 and the second magnetic body 63 can be increased. That is, the plate 65 can reduce the magnetic flux leaking to a rear of the first magnetic body 62, and concentrate the magnetic flux generated from the first magnetic body 62 to the second magnetic body 63.

The driving plate 61 may be pressed against the holder 30 and/or the first housing 50 by the repulsive force between the first and second magnetic bodies 62 and 63, and may be in tight contact with the holder 30 and/or the first housing 50. In the embodiment, since the magnetic force (e.g., repulsive force) between the first magnetic body 62 and the second magnetic body 63 is large, the driving plate 61 may stably support the holder 30, and accordingly, OIS operation may be stably implemented.

Referring to FIG. 13A, the length of the first magnetic body 62 in the second direction may be longer than the length of the second magnetic body 63 in the second direction. Further, referring to FIG. 13B, the length of the first magnetic body 62 in the third direction may be longer than the length of the second magnetic body 63 in the third direction. In another embodiment, the length of the first magnetic body 62 in the second direction may be equal to or shorter than the length of the second magnetic body 63 in the second direction, and the length of the first magnetic body 62 in the third direction may be equal to or shorter than the length of the second magnetic body 63 in the third direction.

In an example, the area of the first surface of the first magnetic body 62 facing the second magnetic body 63 may be larger than the area of the first surface of the second magnetic body 63 facing the first magnetic body 62. In another embodiment, the area of the first surface of the first magnetic body may be equal to or smaller than the area of the first surface of the second magnetic body.

Repulsive force may act between the first magnetic body 62 and the second magnetic body 63. In an example, the first magnetic body 62 may include a first magnet. In an example, the second magnetic body 63 may include a second magnet that exerts repulsive force on the first magnet. In an example, each of the first and second magnetic bodies is a magnet including N pole and S pole. In addition, in an example, the first magnetic body 62 may further include a first yoke that corresponds to the first magnet and is disposed in the recess 64a. In an example, the second magnetic body 63 may further include a second yoke that corresponds to the second magnet and is disposed in the recess 44A in the first housing 50. The first yoke and the second yoke may increase magnetic force (e.g., repulsive force) acting between the first magnetic body 62 and the second magnetic body 63.

In an example, the surfaces of the first magnetic body 62 and the second magnetic body 63 facing each other may have the same polarity (N pole or S pole).

In another embodiment, attractive force may act between the first magnetic body and the second magnetic body, and in this case, the surfaces of the first magnetic body and the second magnetic body facing each other may have opposite polarities.

The plate 65 may alternatively be expressed as “reinforcement member”, “reinforcement plate”, “magnetic member”, or “magnetic body plate”.

In an example, the plate 65 may be or include a magnetic body. In an example, the plate 65 may be a magnetic metal plate or may include a magnetic metal plate. In an example, when the plate 65 is a magnetic body or includes a magnetic body, the magnetic force between the first magnetic body 62 and the second magnetic body 63 can be improved. In an example, the plate 65 may include iron, nickel, cobalt, ferrite, or an alloy containing at least one of these. In an example, the plate 65 may include at least one of iron, carbon, manganese, nickel, chromium, cobalt, or tungsten, or may be an alloy containing at least one of these.

In other embodiments, the plate 65 may be non-magnetic. In an example, the plate 65 may be made of a non-magnetic metal material. In another embodiment, the plate 65 may be made of a non-magnetic material. In an example, the plate 65 may include a non-ferrous metal. In an example, the plate 65 may contain any one of aluminum, gold, silver, copper, lead, zinc, or tin, or may be an alloy containing at least one of these.

The plate 65 may be disposed in the holder 30 by an insert injection method. In an example, at least one of the holder 30, the first housing 50, and the magnetic body support part 64 may be formed of an injection-molded material such as plastic or resin.

In an example, the plate 65 may be disposed inside the magnetic body support part 64 using an insert method. In the embodiment, the plate 65 is sealed inside the magnetic body support part 64, but in other embodiments, at least a portion of the plate 65 may be exposed from the magnetic body support part 64. In an example, at least a portion of the plate 65 may be exposed from at least one of the top, bottom, and side surfaces of the magnetic body support part 64.

In another embodiment, rather than the insert injection method, a mounting groove or groove for mounting or placing the plate 65 on the magnetic body support part 64 may be formed, and the plate may be combined with the magnetic body support part 64 by a method of assembling the plate 65 to the magnetic body support part 64.

Referring to FIG. 13A, a length of the plate 65 in the second direction may be greater than or equal to a length of the first magnetic body 62 in the second direction. Also, referring to FIG. 13B, a length of the plate 65 in the third direction may be greater than a length of the first magnetic body 62 in the third direction.

In another embodiment, the length of the plate 65 in the second direction may be equal to or smaller than the length of the first magnetic body 62 in the second direction, and the length of the plate 65 in the third direction may be equal to or smaller than the length of the first magnetic body 62 in the third direction.

In an example, an area of the first surface (eg, front surface) of the plate 65 facing the first magnetic body 62 is an area of the first surface (eg, rear surface) of the first magnetic body 62 facing the plate 65. In another embodiment, the area of the first surface of the plate 65 may be equal to or smaller than the area of the first surface of the first magnetic body.

In an example, a thickness of the plate 65 may be smaller than a thickness of the first magnetic body 62. The thickness of plate 62 may be a distance from the first side (eg, front surface) of plate 65 to the second side (eg, rear surface) of plate 65. In another embodiment, the thickness of the plate 65 may be equal to or greater than the thickness of the first magnetic body 62.

In an example, the plate 65 may include a first part that overlaps the first magnetic body 62 in the first direction and a second part that does not overlap the first magnetic body 62 in the first direction. In an example, the second part of the plate 65 may be positioned to surround the first part of the plate 65.

FIG. 14 shows a cross-sectional view of a second actuator according to a comparative example. In the comparative example of FIG. 14, the plate 65 according to the embodiment is omitted.

Referring to FIG. 14, in the comparative example, a shock absorber 69A such as poron is adhered to the third housing 643 of the first lens assembly 640 of the first actuator to reduce the amount of shock applied to the second actuator due to shock. However, compared to injection molded material, the manufacturing dimensional tolerance of the poron is large, so it is difficult to manage the tolerance of the poron. As a result, the size of the poron may deviate significantly from the normal standard, and the shock absorber 69A may not sufficiently perform its role. This may cause oscillation of the camera module, the reliability of OIS control may deteriorate, and cracks may occur in the second actuator due to impact.

The magnetic body support part 64 may be damaged or cracks may occur in the magnetic body support part 64 due to a collision between the magnetic body support part 64 and the first housing 50 by an external impact. In particular, the extension portions 94a and 94b of the magnetic body support part 64 are damaged or cracks occur in the extension portions 94a and 94b due to a collision between the extension portions 94a and 94b of the magnetic body support part 64 and the first housing 50 (see dotted line in FIG. 14).

In addition, in the comparative example, the repulsive force acting between the first magnetic body 62 and the second magnetic body 63 is weak, so the driving plate 61 may not be in close contact with the first housing 50 and the holder 30 and the sag of the driving plate 61 may occur. Due to this sag of the driving plate 61, the reliability of OIS driving may deteriorate.

The plate 65 may include a material with greater rigidity than the injection-molded material of the magnetic body support part 64 and/or the injection-molded material of the first housing 50, for example, a metal material. Alternatively, the plate 65 may be formed of a material with greater rigidity than the injection-molded material.

Or, in an example, the plate 65 may include a non-magnetic material that has greater rigidity than the injection-molded material. Or, in an example, the plate 65 may be formed of a non-magnetic material that has greater rigidity than the injection-molded material. Or, in an example, the plate 65 may include a magnetic material that has greater rigidity than the injection-molded material. Alternatively, the plate 65 may be formed of a magnetic material that has greater rigidity than the injection-molded material.

In the embodiment, by disposing the plate 65 on the magnetic body support part 64, the rigidity of the magnetic body support part 64 including the plate 65 can be improved, and it is possible to prevent the magnetic body support part 64 from being damaged by impact and to prevent cracks from occurring in the magnetic body support part 64 due to impact.

Additionally, in an embodiment in which the plate 65 includes a magnetic material or is formed of a magnetic material, the plate 65 can reduce the magnetic flux leaking to the rear of the first magnetic body 62 and concentrate the magnetic flux generated from the first magnetic body 62 on the second magnetic body 63, and increase the repulsive force between the first and second magnetic bodies 62 and 63.

In the embodiment, since the magnetic force (e.g., repulsive force) between the first and second magnetic bodies 62 and 63 is increased by the plate 65, the sag of the driving plate 61 can be prevented, and the driving plate 61 can stably support the holder 30, and as a result, stable OIS operation can be performed and reliability of OIS driving can be secured.

FIGS. 11 and 13B, the plate 65 may be disposed on the body 93 of the magnetic body support part 64. In an example, the plate 65 may not be disposed on the extension portions 94a and 94b of the magnetic body support part 64. In an embodiment in which the plate 65 is a magnetic material, such as a magnet, if a portion of the plate 65 is disposed on the extension portions 94a and 94b of the magnetic body support part 64, the magnetic field interference between the plate 65 and the first OIS magnets 31A and 31B may increase since the distance between the plate 65 and the first OIS magnet 31A, 31B decreases. As the interference of the magnetic field between the plate 65 and the first OIS magnets 31A and 31B increases, the reliability of OIS driving may deteriorate and the effect of image stabilization may be reduced.

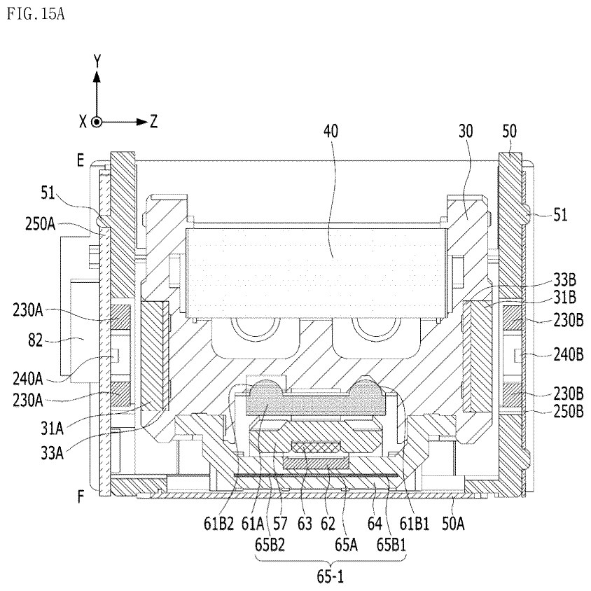

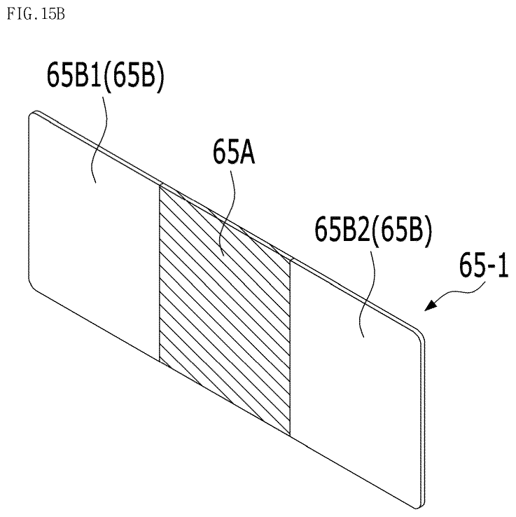

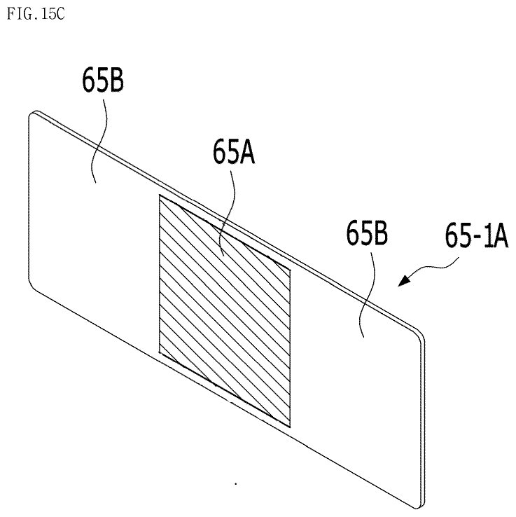

FIG. 15A is a cross-section of the second actuator 320 including the plate 65-1 according to another embodiment, and FIG. 15B is a perspective view of the plate 65-1 of FIG. 15A.

Referring to 15A and 15B, the plate 65-1 may include a magnetic body portion 65A. The magnetic body portion 65A may face the first magnetic body 62 in a first direction, and at least a portion of the magnetic body portion 65A may overlap the first magnetic body 62 in the first direction. Additionally, at least a portion of the magnetic body portion 65A may overlap the second magnetic body 62 in the first direction.

In an example, the plate 65-1 may include a non-magnetic body portion 65B. The magnetic body portion 65A among the magnetic body portion 65A and the non-magnetic body portion 65B may be located farther from the first OIS magnets 31A and 31B than the non-magnetic body portion 65B.

In an example, the plate 65-1 may include a first non-magnetic body portion 65B1 located on the left side of the magnetic body portion 65A and a second non-magnetic body portion 65B2 located on the right side of the magnetic body portion 65A. The magnetic body portion 65A may be positioned between the first non-magnetic body portion 65B1 and the second non-magnetic body portion 65B2. The magnetic body portion 65A may form a boundary with each of the first non-magnetic body portion 65B1 and the second non-magnetic body portion 65B2.

In an example, the front surface of the magnetic body portion 65A and the front surface of the non-magnetic body portion 65B may be located on the same plane. In an example, the rear surface of the magnetic body portion 65A and the rear surface of the non-magnetic body portion 65B may be located on the same plane.

For example, the length of the magnetic body portion 65A in the second direction may be equal to the length of the non-magnetic body portion 65B in the second direction. Also, in an example, the length of the magnetic body portion 65A in the third direction may be smaller than the length of the non-magnetic body portion 65B in the third direction.

FIG. 15C is a variant example 65-1A of the plate of FIG. 15B.

Referring to FIG. 15C, the plate 65-1A may include a magnetic body portion 65A and a non-magnetic body portion 65B, and the non-magnetic body portion 65B may surround at least a portion of the magnetic body portion 65A. In an example, the non-magnetic body portion 65B may wrap around the magnetic body portion 65A. In an example, the length of the magnetic body portion 65A in the second direction may be smaller than the length of the non-magnetic body portion 65B in the second direction. Also, in an example, the length of the magnetic body portion 65A in the third direction may be smaller than the length of the non-magnetic body portion 65B in the third direction.

Referring to FIGS. 15B and 15C, the magnetic body portion 65A may overlap the first magnetic body 62 in the first direction, and the non-magnetic body portion 65B may not overlap the first magnetic body 62 in the first direction or include a part that does not overlap the first magnetic body 62 in the first direction. In addition, in the embodiments of FIGS. 15B and 15C, the magnetic body portion 65A is disposed farther from the first OIS magnets 31A and 31B than the non-magnetic body portion 65B, so the interference of magnetic field between the first OIS magnets 31A and 31B and the plate 65-1, 65-1A can be reduced. That is, the embodiment of FIGS. 15B and 15B can increase the repulsive force between the first magnetic body 62 and the second magnetic body 63, and at the same time, can reduce the interference of magnetic fields between the first OIS magnets 31A, 31B and the plates 65-1, 65-1A, and thereby the reliability of OIS driving can be further improved.

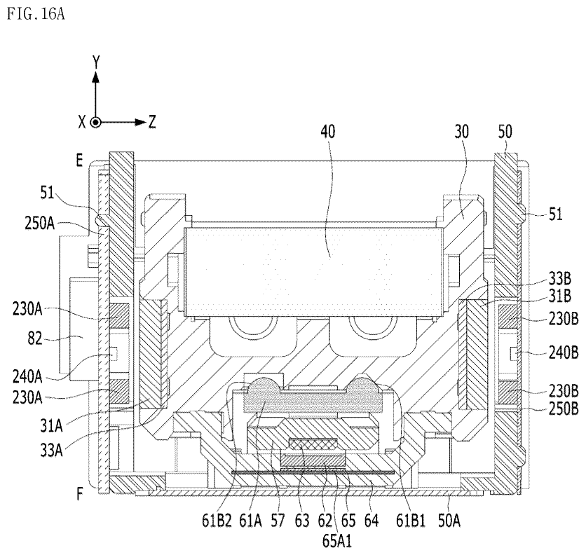

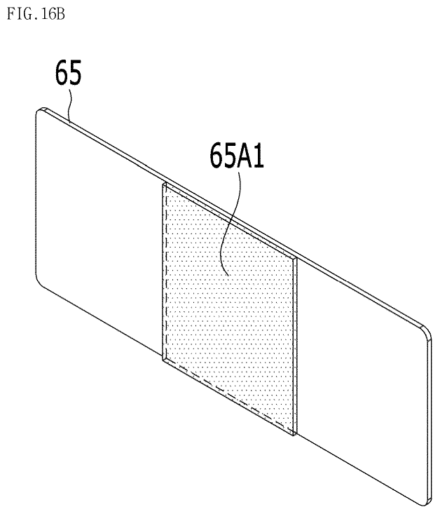

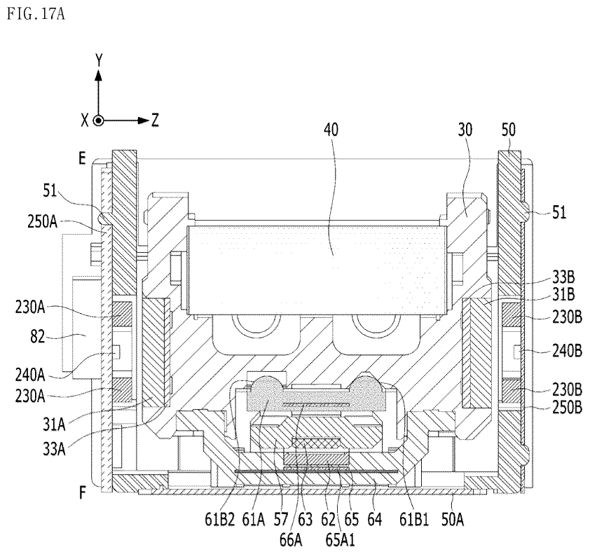

FIG. 16A is a cross-sectional view of the second actuator 320 according to another embodiment, and FIG. 16B is a perspective view of the plate 65 and the magnetic body plate 65A1 of FIG. 16A.

Referring to 16A and 16B, the plate 65 may include or be a non-magnetic body. That is, the plate 65 may be a non-magnetic body, for example, a non-magnetic metal plate. The plate 65 may serve as a reinforcing member and may serve to increase the rigidity of the magnetic body support part 64.

The second actuator 320 may include a magnetic body plate 65A1 that faces or overlaps the first magnetic body 62 in the first direction. In an example, the magnetic body plate 65A1 may be a metal plate with magnetism. In an example, at least a portion of the magnetic body plate 65A1 may overlap the second magnetic body 63 in the first direction.

The magnetic body plate 65A1 may be disposed between the plate 65 and the first magnetic body 62. The magnetic body plate 65A1 may overlap a portion of the plate 65 in the first direction.

In an example, the plate 65 may include a first part that overlaps the magnetic body plate 65A1 in the first direction and a second part that does not overlap the magnetic body plate 65A1 in the first direction. In an example, the first part of the plate 65 among the first and second parts of the magnetic body plate 65A1 may be located farther from the first OIS coils 31A, 31B than the second portion of plate 65.

The magnetic body plate 65A1 of FIG. 16A may be located between one end and the other end of the plate 65. In another embodiment, when viewed in the first direction or from the front, the magnetic body plate 65A1 may be arranged to be surrounded by the plate 65, as shown in FIG. 15C. That is, the length of the magnetic body plate 65A1 in the second direction may be smaller than the length of the plate 65 in the second direction. Additionally, the length of the magnetic body plate 65A1 in the third direction may be smaller than the length of the plate 65 in the third direction.

The magnetic body plate 65A1 may be in contact with the plate 65. In an example, the magnetic body plate 65A1 may be in contact with the front surface of the plate 65. In another embodiment, the magnetic body plate 65A1 may be arranged to be spaced apart from the plate 65.

Embodiment in FIGS. 16A and 16B can increase the repulsive force between the first magnetic body 62 and the second magnetic body 63 and simultaneously reduce interference of the magnetic field between the first OIS magnets 31A and 31B and the plates 65-1 and 65-1A, and thus the reliability of OIS operation can be further improved.

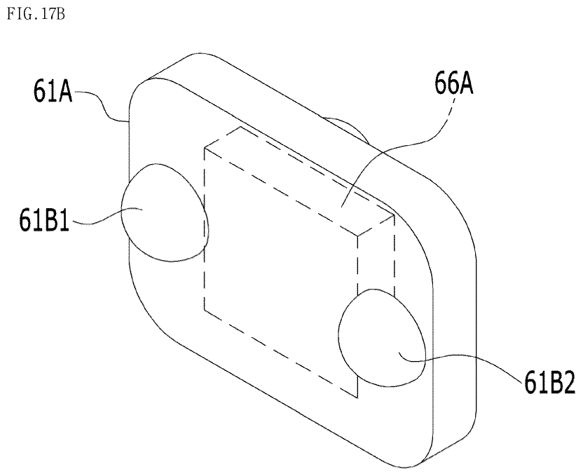

FIG. 17A is a cross-sectional view of the second actuator 320 according to another embodiment, and FIG. 17B is a perspective view of the driving plate 61 on which the plate 66A of FIG. 17A is disposed.

Referring to FIGS. 17A and 17B, the second actuator 320 may include the plate 66A disposed on the driving plate 61.

The plate 66A may be disposed between the front and rear surfaces of the driving plate 61. At least a portion of the plate 66A may face or overlap the second magnetic body 63 in the first direction. In an example, at least a portion of the plate 66A may overlap the first magnetic body 63 in the first direction. Additionally, at least a portion of the plate 66A may overlap the magnetic body plate 65A1 in the first direction.

In an example, the plate 66A may be or include a magnetic body. For example, the plate 66A may be a magnetic metal plate or may include a magnetic metal plate. In an example, when the plate 66A is a magnetic body or includes a magnetic body, an attractive force may be formed between the plate 66A and the second magnetic body 63, and the magnetic plate 61 can come into close contact with the holder 30 and the first housing 50 due to attractive force, and the driving plate 61 can stably support the holder 30 and thus a stable OIS operation can be performed.

In an example, the plate 66A may be disposed inside the driving plate 61 using an insert method. In the embodiment, the plate 66A is sealed inside the driving plate 61, but in other embodiments, at least a portion of the plate 66A may be exposed from the driving plate 61. In an example, at least a portion of the plate 66A may be exposed from at least one of the top surface, the bottom surface, and the side surface of the driving plate 61.

In another embodiment, instead of using the insert injection method, a mounting groove or groove for mounting or placing the plate 66A at the driving plate 61 may be formed, and the plate 66A and the driving plate 61 may be coupled by assembling the plate 66A to the driving plate 61.

In another embodiment, the plate 66A may be disposed on one of the front surface and the rear surface of the driving plate 61.

In another embodiment, the driving plate 61 may include a magnetic body portion. In an example, a portion of the driving plate 61 may be a magnetic body portion. At this time, the magnetic body portion of the driving plate 61 may face or overlap the second magnetic body 63 in the first direction. Or, in an example, at least a portion of the driving plate 61 may overlap the first magnetic body 63 in the first direction. Or, in an example, the entire driving plate 61 may be a magnetic body.

The length of the plate 66A in the second direction may be greater than or equal to the length of the second magnetic body 63 in the second direction. In another embodiment, the length of the plate 66A in the second direction may be smaller than the length of the second magnetic body 63 in the second direction.

The length of the plate 66A in the third direction may be greater than the length of the second magnetic body 63 in the third direction. In another embodiment, the length of the plate 66A in the third direction may be less than or equal to the length of the second magnetic body 63 in the third direction.

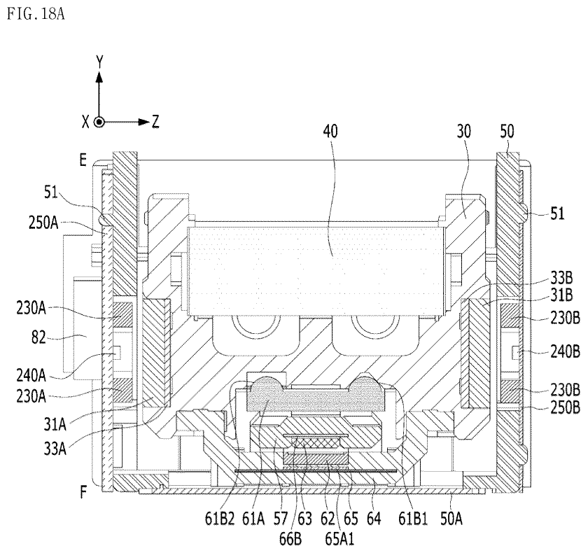

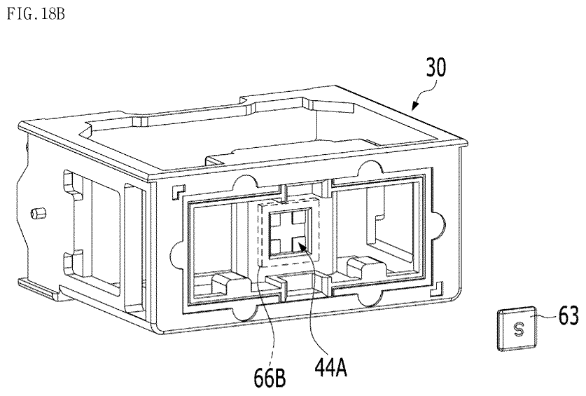

FIG. 18A is a cross-sectional view of the second actuator 320 according to another embodiment, and FIG. 18B is a perspective view of the first housing 50 on which the plate 66B of FIG. 18A is disposed.

Referring to FIGS. 18A and 18B, the second actuator 320 may include a plate 66B disposed in the first housing 50.

The plate 66B may be disposed in front of the second magnetic body 63 disposed on the first housing 50. In an example, the second magnetic body 63 may be disposed between the plate 66B and the first magnetic body 62. In an example, the plate 66B may be disposed on the protrusion 57 of first housing 50. In an example, the plate 66B may be disposed further inside the groove 44 formed in the protrusion 57 of the first housing 50.

At least a portion of the plate 66B may face or overlap the second magnetic body 63 in the first direction. In an example, at least a portion of the plate 66B may overlap the first magnetic body 63 in the first direction. Additionally, at least a portion of the plate 66B may overlap the magnetic body plate 65A1 in the first direction.

For example, the plate 66B may be or include a magnetic body. For example, the plate 66B may be a magnetic metal plate or may include a magnetic metal plate. For example, the plate 66B can reduce the magnetic flux of the second magnetic body 63 leaking to the front of the second magnetic body 63, and concentrate the magnetic flux generated from the second magnetic body 63 to the first magnetic body 62. The repulsive force between the first and second magnetic bodies 62 and 63 can be increased.

In the embodiment, since the magnetic force (e.g., repulsive force) between the first and second magnetic bodies 62 and 63 is increased by the plate 66B, sagging of the driving plate 61 can be prevented, and the driving plate 61 can stably support the holder 30, and as a result, stable OIS operation can be performed and reliability of OIS driving can be secured.

Additionally, an attractive force may be formed between the plate 66B and the first magnetic body 62, and the magnetic body plate 61 may be in close contact with the holder 30 and the first housing 50 due to the attractive force, and the driving plate 61 can stably support the holder 30, and because of this, stable OIS operation can be performed.

For example, the plate 66B may be disposed inside the first housing 50 by an insert method. In the embodiment, the plate 66B is sealed inside the first housing 50, but in other embodiments, at least a portion of the plate 66B may be exposed from the first housing 50. For example, at least a portion of the plate 66B may be exposed from at least one of the top surface, the bottom surface, and the side surface of the first housing 50. In another embodiment, instead of using the insert injection method, a mounting groove or groove for mounting or placing the plate 66B at the first housing 50 may be formed, and the plate 66B and the first housing may be coupled by the method in which the plate 66B is assembled to the first housing 50.

The plates 66A and 66B of FIGS. 17A and 18A may be alternatively expressed as “reinforcement member”, “reinforcement plate”, “magnetic member”, or “magnetic plate”. The plates 66A and 66B of FIGS. 17A and 18A may be applied or analogously applied to the embodiments of FIGS. 13B, 15A, and 16A described above.

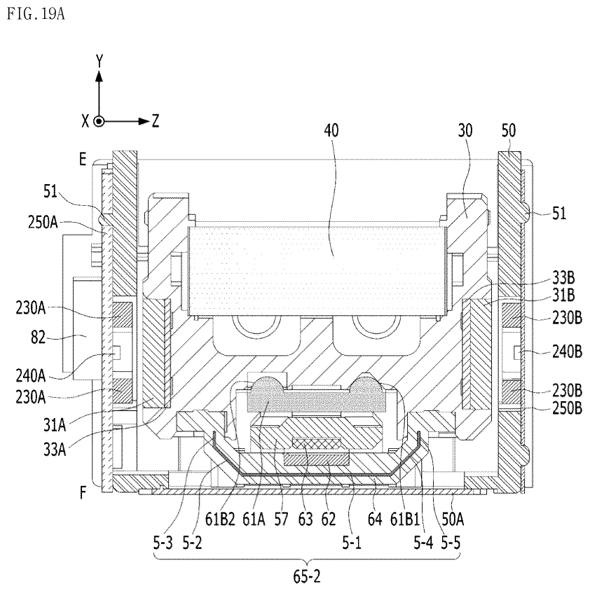

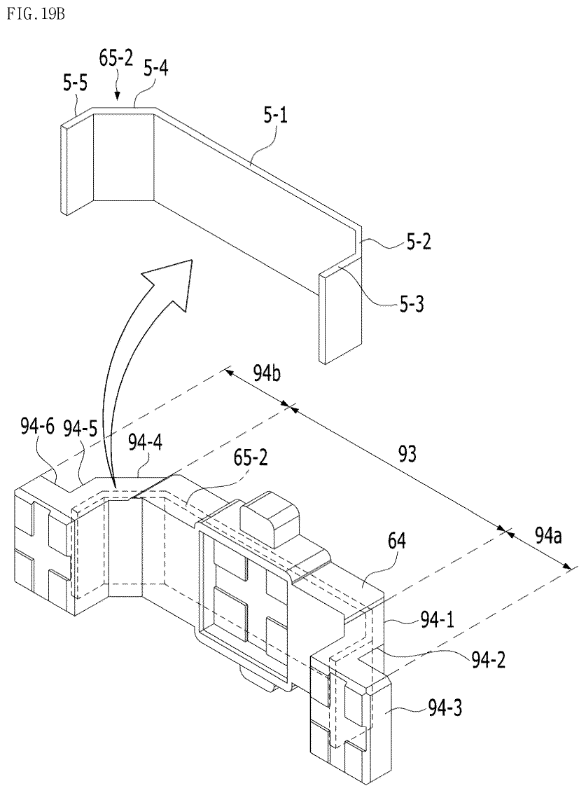

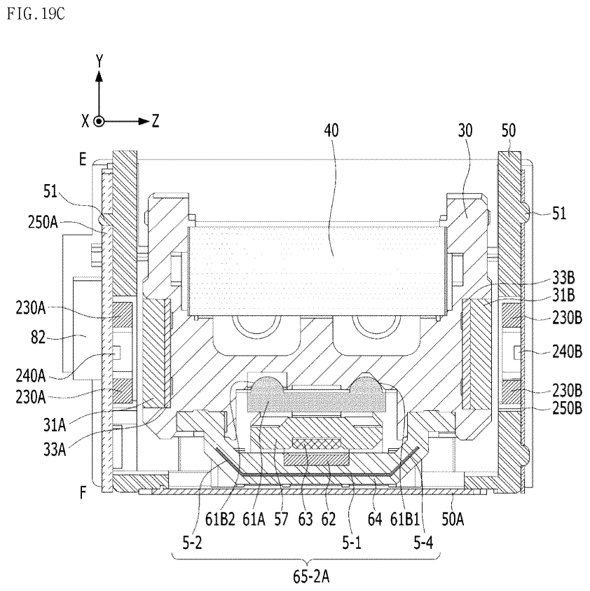

FIG. 19A is a cross-sectional view of the second actuator 320 according to another embodiment, and FIG. 19B is a perspective view of the magnetic body support part 64 on which the plate 65-2 of FIG. 19A is disposed.

Referring to FIGS. 19A and 19B, the plate 65-2 may be a variant example of the plate 65 of FIG. 13B. The plate 65-2 may be disposed on the body 93 and the extension portions 94a and 94b of the magnetic body support part 64.

The description of the material of the plate 65 in FIG. 13B can be applied or analogously applied to the plate 65-2 in FIG. 19A.

For example, the plate 65-2 includes a body 5-1 disposed on the body 93 of the magnetic body support part 64, and extension parts 5-2 to 5-5 extending from the body 5-1 and disposed on an extension portion 94a of the magnetic body support part 64. For example, the extension parts 5-2 to 5-5 may be bent from the body 5-1. For example, the extension parts 5-2 to 5-5 may be bent in a direction from the body 5-1 toward the holder 30 or the optical member 40.

For example, the plate 65-2 extends from one side (or one end) of the body 5-1 and includes a first extension part 5-2 and 5-3 disposed on the first extension portion 94a of the magnetic body support part 64 and a second extension part 5-4, 5-5 extending from the other side (or other end) of the body 5-1 and disposed on the second extension portion 94b of the magnetic body support part 64.

For example, the first extension part 5-2 and 5-3 includes a first portion 5-2 bent from one side (or one end) of the body 5-1 and a second portion 5-3 bent from the first portion 5-2.

Also, for example, the second extension part 5-4 and 5-5 includes a first portion 5-4 bent from the other side (or other end) of the body 5-1 and a second portion 5-5 bent from the first portion 5-4. In FIG. 19B, each of the first and second extension portions includes two bent portions, but in another embodiment, each of the first and second extension portions may include one bent portion or three or more bent portions.

For example, the first extension part 5-2 and 5-3 may be disposed at the first and second portions 94-1 and 94-2 of the first extension portion 94a of the magnetic body support part 64. The second extension part 5-4 and 5-5 may be disposed at the fourth and fifth portions 94-4 and 94-5 of the second extension portion 94b of the magnetic body support part 64.

In another embodiment, each of the first and second extension parts of the plate 65-2 may be curved.

Since the plate 65-2 of FIG. 19A is disposed at the extension portions 94a and 94b of the magnetic body support part 64, compared to the embodiment of FIG. 13b, the rigidity of the magnetic body support part 64 can be further increased, and thus as a result, it is possible to more effectively prevent the magnetic body support part 64 from being damaged or cracks occurring due to impact.

FIG. 19C is a cross-sectional view of a second actuator including the plate according to another embodiment.

FIG. 19C may be a variant example of FIG. 19A. The embodiment of FIG. 19C may have a structure in which the second part 5-3 of the first extension portion and the second part 5-5 of the second extension portion of the plate 65-2 of FIG. 19A are omitted.

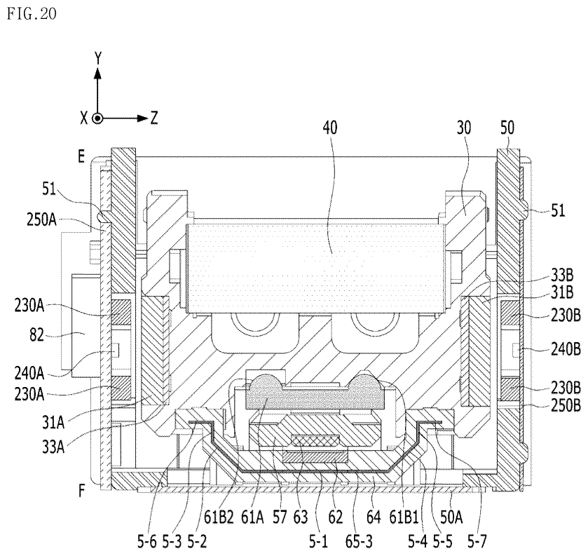

FIG. 20 is a cross-sectional view of a second actuator including a plate 65-3 according to another embodiment. FIG. 20 may be a variant example of the plate 65-2 of FIG. 19A.

The plate 65-3 of FIG. 20 may include a body 93, a first extension portion, and a second extension portion.

For example, the first extension portion of the plate 65-3 may be disposed at the first to third portions 94-1 to 94-3 of the first extension portion 94a of the magnetic body support part 64, and the second extension portion of the plate 65-3 may be disposed at the fourth to fifth portions 94-4 to 94-6 of the second extension portion 94b of the magnetic body support part 64.

The first extension portion of the plate 65-3 in FIG. 20 includes the first part 5-2, the second part 5-3, and the third part 5-6 bent from the second part 5-3 and disposed at third portion 94-3 of the magnetic body support part 64. In addition, the second extension portion of the plate 65-3 in FIG. 20 includes the first part 5-4, the second part 5-5, and the third part 5-7 bent from the second part 5-5 and disposed at the sixth portion 94-6 of the magnetic body support part 64. The third part 5-6 of the first extension portion of the plate 65-3 and the third part 5-7 of the second extension portion of the plate 65-3 may be bent in opposite directions.

Compared to FIG. 19A, since the extension portion of the plate 65-3 in FIG. 20 further includes the third parts 5-6 and 5-7, the rigidity of the magnetic body support part 64 can be further increased, thereby as a result, it is possible to more effectively prevent the magnetic body support part 64 from being damaged or cracks occurring due to impact.

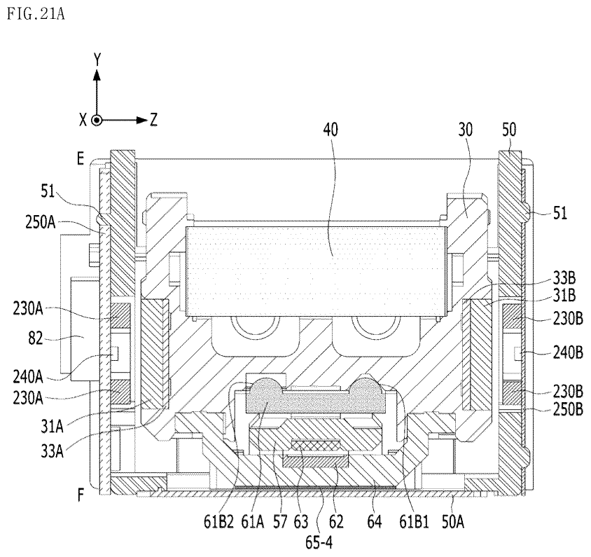

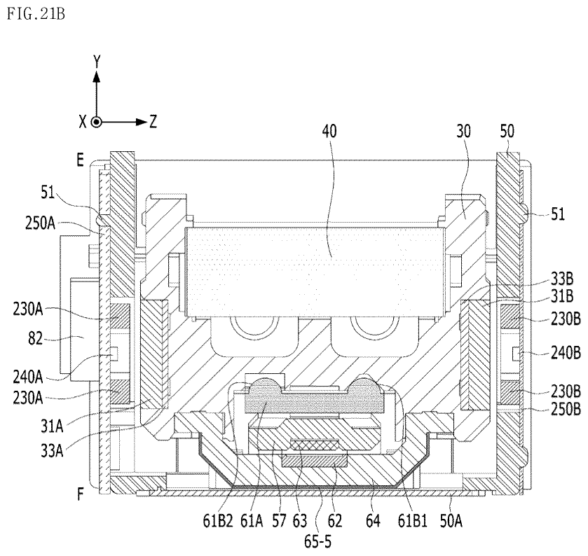

FIG. 21a is a cross-sectional view of the second actuator 320 including the plate 65-4 according to another embodiment.

Referring to FIG. 21A, compared to FIG. 13B, the plate 65-4 is arranged in a different position. The plate 65-4 may be disposed, coupled, or attached to the outer peripheral surface of the magnetic body support part 64. For example, the plate 65-4 may be disposed, coupled, or attached to the rear surface of the magnetic body support part 64. For example, a groove for disposing or seating the plate 65-4 may be formed at the rear surface of the magnetic body support part 64. The rear surface of the magnetic body support part 64 may be the opposite side to the front surface of the magnetic body support part 64 on which the first magnetic body 62 is disposed.

For example, the plate 65-4 in FIG. 21A is different only in the position in which it is disposed, and the description of the plate 65 in FIG. 13B can be applied or analogously applied to the plate 65-4 in FIG. 21A.

Descriptions of the embodiments of FIGS. 15A to 15C, 16A, 17A, and 18A may be applied or analogously applied to the embodiment of FIG. 21A.

FIG. 21B is a cross-sectional view of the second actuator 320 including the plate 65-5 according to another embodiment.

Compared to the embodiment of FIG. 19A, the plate 65-5 of FIG. 21B is arranged in a different position. For example, the plate 65-5 may be disposed, coupled, or attached to the outer peripheral surface of the magnetic body support part 64. For example, the plate 65-5 may be disposed, coupled, or attached to the rear surface of the magnetic body support part 64. For example, a groove for disposing or seating the plate 65-5 may be formed at the rear surface of the magnetic body support part 64. The rear surface of the magnetic body support part 64 may be the opposite side of the front surface of the magnetic body support part 64 on which the first magnetic body 62 is disposed.

The plates 65-4 and 65-5 of FIGS. 21A and 21B have the advantage of being easily coupled or attached to the magnetic body support part 64 using an adhesive.

Descriptions of the embodiments of FIGS. 15A to 15C, 16A, 17A, and 18A may be applied or analogously applied to the embodiment of FIG. 21A. Additionally, the description of the embodiment of FIG. 20 may be applied to or analogously applied to FIG. 21B.

The magnetic body portion 65A and the non-magnetic body portion 65B of FIGS. 15B and 15C may be applied or applied to the plates 65-2 to 65-5 according to the embodiments of FIGS. 19B, 20, 21A, and 21B. In this case, the magnetic body portion 65A may be formed at a portion of the body 5-1 of the plates 65-2 to 65-5, and the non-magnetic body portion 65B may be the remaining portion of the body 5-1 of the plates 65-2 to 65-5 and the extension parts 5-2 to 5-5, or 5-2 to 5-7.

Additionally, the magnetic body plate 65A1 of FIG. 16A may be applied or analogously applied to the embodiments of FIGS. 19A, 20, 21A, and 21B. Additionally, the plate 66A in FIG. 17A and the plate 66b in FIG. 18A can be applied or analogously applied to the embodiments of FIGS. 19A, 20, 21A, and 21B.

Next, the second driving part 70 will be described.

The second driving part 70 tilts the holder 30 in the second or third direction or rotates the holder 30 at a predetermined angle.

The second driving part 70 may include an OIS magnet 31 and an OIS coil 230. OIS magnet is alternatively expressed as “magnet” or “magnet unit”. OIS coil is alternatively expressed as “coil” or “coil unit”. In addition, the second driving part 70 may include an OIS position sensor unit 240, and a first board unit 250.

The OIS magnet 31 may be disposed in the holder 30. In an example, the OIS magnet 31 may include first OIS magnets 31A and 31B and a second OIS magnet 32.

In an example, the first OIS magnet may include a first magnet unit 31A disposed on the third side portion 31c of the holder 30 and a second magnet unit 31B disposed on the fourth side portion 31d of the holder 30. In an example, the first magnet unit 31A may face or overlap the second magnet unit 31B in the third direction. In an example, the first magnet unit 31A may be disposed in the first seating recess 16A in the first side portion 31c of the holder 30, and the second magnet unit 31B may be disposed in the first seating recess 16A in the second side portion 31d of the holder 30.

The second OIS magnet may include a third magnet unit 32 disposed on the lower surface 17 of the holder 30. The third magnet unit 32 may be disposed in the second seating recess 16B in the holder 30.

Each of the first to third magnet units 31A, 31B, and 32 may be a monopolar-magnetized magnet having one N pole and one S pole. However, the disclosure is not limited thereto. In another embodiment, each of the first to third magnet units may be a bipolar-magnetized magnet having two N poles and two S poles. In still another embodiment, at least one of the first to third magnet units 31A, 31B, and 32 may be a monopolar-magnetized magnet, and the remaining magnet units may be bipolar-magnetized magnets.

The OIS coil 230 may be disposed on the first housing 50. In an example, OIS coil may be disposed so as to correspond to or face the OIS magnet 31. In an example, the OIS coil 230 may include first OIS coils 230A and 230B, which correspond to, face, or overlap the first OIS magnets 31A and 31B in the third direction, and a second OIS coil 230C, which corresponds to, faces, or overlaps the second OIS magnet 32 in the second direction.

In an example, the first OIS coil may include a first OIS coil unit 230A, which corresponds to, faces, or overlaps the first magnet unit 31A in the third direction, and a second OIS coil unit 230B, which corresponds to, faces, or overlaps the second magnet unit 31B in the third direction. In an example, the second OIS coil may include a third OIS coil unit 230C, which corresponds to, faces, or overlaps the third magnet unit 32 in the second direction.

In an example, the first OIS coil unit 230A may be disposed on the third side portion 28C (e.g., in the first hole 54A) of the first housing 50, the second OIS coil unit 230B may be disposed on the fourth side portion 28D (e.g., in the second hole 54B) of the housing 50, and the third OIS coil unit 230C may be disposed on the lower portion 28B (e.g., in the third hole 54C) of the first housing 50.

For example, the first OIS coil unit 230A may have a closed curve or ring shape including a cavity or a hole. The first OIS coil unit 230A may be formed in a shape of a coil ring wound in the clockwise or counterclockwise direction about a third axis parallel to the third direction.

The second OIS coil unit 230B may have a closed curve or ring shape including a cavity or a hole. The second OIS coil unit 230B may be formed in a shape of a coil ring wound in the clockwise or counterclockwise direction about the third axis parallel to the third direction.

The third OIS coil unit 230C may have a closed curve or ring shape including a cavity or a hole. The third OIS coil unit 230C may be formed in a shape of a coil ring wound in the clockwise or counterclockwise direction about a second axis parallel to the second direction.

Referring to FIG. 12, first electromagnetic forces F21, F22, F31, and F32 may be generated by interaction between the first OIS magnets 31A and 31B and the first OIS coils 230A and 230B. That is, the first electromagnetic forces may be generated by interaction between the first magnet unit 31A and the first OIS coil unit 230A and interaction between the second magnet unit 31B and the second OIS coil unit 230B. In an example, 1-1^{st} electromagnetic forces F22 and F32 may be generated by interaction between the first magnet unit 31A and the first OIS coil unit 230A, 1-2^{nd} electromagnetic forces F21 and F31 may be generated by interaction between the second magnet unit 31B and the second OIS coil unit 230B, and the first electromagnetic forces may include the 1-1^{st} electromagnetic forces F22 and F32 and the 1-2^{nd} electromagnetic forces F21 and F31.

In addition, second electromagnetic forces F1 and F2 may be generated by interaction between the second OIS magnet 32 and the third OIS coil unit 230C.

The OIS moving unit (e.g., holder 30) may undergo second-axis (e.g., X-axis) tilt due to the first electromagnetic forces F21, F22, F31, and F32. Here, the second-axis (e.g., X-axis) tilt means tilt of the OIS moving unit with respect to the second axis (X-axis) or rotation of the OIS moving unit at a predetermined angle about the second axis (X-axis).

The OIS moving unit may undergo third-axis (e.g., Y-axis) tilt due to the second electromagnetic forces F1 and F2. Here, the third-axis (Y-axis) tilt means tilt of the OIS moving unit with respect to the third axis or rotation of the OIS moving unit at a predetermined angle about the third axis.

In this case, the OIS moving unit may include the holder 30. In addition, the OIS moving unit may further include components that are coupled or mounted to the holder 30, e.g., the OIS magnets 31A, 31B, and 32, the yoke 33, and the magnetic body support part 64. In addition, the OIS moving unit may further include at least one of the driving plate 61 or the first magnetic body 62.

In addition, the first OIS coil unit 230A and the second OIS coil unit 230B may overlap each other in the third direction (Y-axis direction), and the first OIS magnet 31A and the second OIS magnet 31B may overlap each other in the third direction. Due to this arrangement, electromagnetic forces may be applied in a balanced manner to the first side portion 31c and the fourth side portion 31d of the holder 30, whereby the X-axis tilt may be performed accurately and precisely.

In another embodiment, the OIS moving unit (e.g., holder 30) may undergo third-axis (e.g., Y-axis) tilt due to the electromagnetic forces generated by interaction between the first OIS magnets 31A and 31B and the first OIS coils 230A and 230B, and may undergo second-axis (e.g., X-axis) tilt due to the electromagnetic forces generated by interaction between the second OIS magnet 32 and the third OIS coil unit 230C.

The camera device 200 may further include yokes 33 (33A, 33B, and 33C) disposed on the OIS magnets 31 and 32.

In an example, the yokes 33 may include a first yoke 33A disposed on the first magnet unit 31A, a second yoke 33B disposed on the second magnet unit 31B, and a third yoke 33C disposed on the third magnet unit 32.

In an example, the first yoke 33A may be disposed in the first seating recess 16A in the third side portion 31c of the holder 30. In an example, the first yoke 33A may be disposed farther inward then the first magnet unit 31A. The second yoke 33B may be disposed in the first seating recess 16A in the fourth side portion 31d of the holder 30. In an example, the second yoke 33B may be disposed farther inward than the second magnet unit 31B. The third yoke 33C may be disposed in the second seating recess 16B in the holder 30. The third yoke 33C may be disposed farther inward than the third magnet unit 32. The first yoke 33A and the second yoke 33B may increase the first electromagnetic forces, and the third yoke 33C may increase the second electromagnetic forces.

A first board unit 250 may be disposed in the first housing 50. In an example, the first board unit 250 may be coupled to the first housing 50. The first board unit 250 may be conductively connected to the OIS coil 230 and may supply a driving signal to the OIS coil 230.

In an example, the first OIS coil unit 230A and the second OIS coil unit 230B may be connected to each other in series, and the first board unit 250 may supply a first driving signal to the first and second OIS coil units 230A and 230B connected to each other in series. In addition, the first board unit 250 may supply a second driving signal to the third OIS coil unit 230C.

The first board unit 250 may include a first circuit board 250A disposed on the third side portion 28C of the first housing 50, a second circuit board 250B disposed on the fourth side portion 28D of the first housing 50, and a third circuit board 250C disposed on the lower portion 27B of the first housing 50.

Although the first circuit board 250A is illustrated in FIG. 5 as being spaced apart from the third circuit board 250C, the first to third circuit boards 250A to 250C may be integrated into a single board and may be conductively connected to each other. In another embodiment, at least one of the first to third circuit boards may not be integrated with the remaining circuit boards but may be conductively connected thereto.

The first circuit board 250A may include a hole 251A formed therein so as to be coupled to the coupling protrusion 51 of the third side portion 28C of the first housing 50. In addition, the first circuit board 250A may include a plurality of terminals 251.

The first OIS coil unit 230A may be disposed or mounted on the first surface of the first circuit board 250A, and the plurality of terminals 251 may be disposed on the second surface of the first circuit board 250A. The first surface of the first circuit board 250A may be a surface facing the outer side surface of the third side portion 28C of the first housing 50. The second surface of the first circuit board 250A may be a surface opposite the first surface of the first circuit board 250A.

The first board unit 250 may include bent portions interconnecting the second circuit board 250B and the third circuit board 250C and interconnecting the first circuit board 250A and the third circuit board 250C.

The second circuit board 250B may include a hole 251B formed therein so as to be coupled to the coupling protrusion 51 of the fourth side portion 28D of the first housing 50. The third circuit board 250C may include a hole 251C formed therein so as to be coupled to the coupling protrusion 52B of the lower portion 28B of the first housing 50.

The second OIS coil unit 230B may be disposed or mounted on the first surface of the second circuit board 250B. The first surface of the second circuit board 250B may be a surface facing the outer side surface of the fourth side portion 28C of the first housing 50.

The third OIS coil unit 230C may be disposed or mounted on the first surface of the third circuit board 250C. The first surface of the third circuit board 250C may be a surface facing the outer surface of the lower portion 28B of the first housing 50.

The first board unit 250 may include at least one of a rigid printed circuit board (PCB), a flexible printed circuit board (PCB), or a rigid flexible printed circuit board (PCB). In addition, the first board unit 250 may include a wiring pattern conductively connecting the components disposed on the first to third circuit boards 250A, 250B, and 250C to the plurality of terminals 251.

The camera device 200 may further include a gyro sensor 82 disposed on the first board unit 250. For example, the gyro sensor 82 may be a 2-axis, 3-axis, or 5-axis gyro sensor or an angular speed sensor.

The camera device 200 may further include a second driver 260 disposed on the first board unit 250. In an example, the second driver 260 may be disposed or mounted on the first circuit board 250A. In an example, the second driver 260 may be disposed in the first housing 50. In an example, the second driver 260 may be disposed or mounted on the first surface of the first circuit board 250A of the first housing 50.

The second driver 260 may be conductively connected to the first OIS coils 230A and 230B and the second OIS coil 230C. In addition, driver 260 may be conductively connected to the first OIS position sensors 240A and 240B and the second OIS position sensor 240C.

In an example, the second driver 260 may supply a driving signal to each of the first OIS position sensors 240A and 240B and the second OIS position sensor 240C, and may receive a first output signal from the first OIS position sensors 240A and 240B and a second output signal from the second OIS position sensor 240C.

In addition, in an example, the second driver 260 may supply the first driving signal (e.g., driving current or driving voltage) to the first OIS coils 230A and 230B, and may perform feedback control on the first driving signal using the first output signal from the first OIS position sensors 240A and 240B.

In addition, in an example, the second driver 260 may supply the second driving signal (e.g., driving current or driving voltage) to the second OIS coil 230C, and may perform feedback control on the second driving signal using the second output signal from the second OIS position sensor 240C. For example, the second driver 260 may alternatively be referred to as an “OIS driver”, a “second driver IC”, or an “OIS controller”.

In addition, the camera device 200 may further include a cover plate 50A disposed on the second side portion 28B of the first housing 50 in order to cover the opening 55 in the first housing 50. The cover plate 50A may be coupled or attached to the outer side surface of the second side portion 28B of the first housing 50, and may prevent foreign substances from entering the first housing 50.

A groove 109 for placing or seating the cover plate 50A may be formed at the outer surface of the second side 28B of the first housing 50. Additionally, the cover plate 50A may include a coupling protrusion 51-1 protruding in the second direction or the third direction, and the first housing 50 may include a coupling groove 51-2 for coupling with a coupling protrusion 51-1 of the cover plate 50A.

The cover plate 50A may be formed of a non-magnetic material. For example, the cover plate 50A may be formed of an injection-molded material such as resin or plastic like the first housing 50.

In another embodiment, the cover plate 50A may include a magnetic body or may be made of a magnetic material. For example, the cover plate 50A may be a magnetic body plate. When the cover plate 50A is a magnetic body plate, the magnetic flux of the first magnetic body 62 leaking to the rear of the first magnetic body 62 can be reduced, and the magnetic flux generated from the first magnetic body 62 can be concentrated to the second magnetic body 63, and the repulsive force between the first and second magnetic bodies 62 and 63 can be increased. As a result, sagging of the driving plate 61 can be prevented, the driving plate 61 can stably support the holder 30, stable OIS operation can be performed, and reliability of OIS driving can be secured.

The OIS position sensor unit 240 detects the position of the OIS moving unit in the second direction and/or the third direction according to movement of the OIS moving unit, and outputs an output signal corresponding to the result of the detection. The OIS position sensor unit 240 may alternatively be referred to as a “second position sensor unit”.

The OIS position sensor unit 240 may include a plurality of position sensors.

In an example, the OIS position sensor unit 240 may include first OIS position sensors 240A and 240B and a second OIS position sensor 240C.

The first OIS position sensors 240A and 240B may at least partially correspond to, face, or overlap the first OIS magnet 31 in the third direction, and may detect the magnetic field intensity of the first OIS magnet 31.

In an example, the first OIS position sensor may include a first sensor 240A disposed or mounted on the first circuit board 250A and a second sensor 240B disposed or mounted on the first board 250-1 of the second circuit board 250B. In an example, the first sensor 240A may be disposed in the cavity (or hole) in the first OIS coil unit 230A, and the second sensor 240B may be disposed in the cavity (or hole) in the second OIS coil unit 230B.

For example, each of the first sensor 240A and the second sensor 240B may be a Hall sensor including first and second input terminals and first and second output terminals.

The first and second input terminals of the first sensor 240A and the first and second input terminals of the second sensor 240B may be connected in parallel to each other, and the second driver 260 may supply a driving signal or power to the first and second input terminals of the first and second sensors 240A and 240B connected in parallel to each other.

The first and second output terminals of the first sensor 240A and the first and second output terminals of the second sensor 240B may be connected to each other in series, and a first output signal may be output from both ends of the first and second output terminals of the first and second sensors 240A and 240B connected to each other in series. The first output signal may be transmitted to the second driver 260.

At least a portion of the second OIS position sensor 240C may correspond to, face, or overlap the second OIS magnet 32 in the second direction, and may detect the magnetic field intensity of the second OIS magnet 32.

In an example, the second OIS position sensor 240C may include a third sensor 240C1 and a fourth sensor 240C2 disposed or mounted on the third circuit board 250C. The third sensor 240C1 and the fourth sensor 240C2 may face or overlap the third OIS magnet 32 in the second direction. In an example, the third sensor 240C1 and the fourth sensor 240C2 may be arranged so as to be spaced apart from each other in the third direction. In an example, the third sensor 240C1 and the fourth sensor 240C2 may be disposed in the cavity (or hole) in the third OIS coil unit 230C.

For example, each of the third sensor 24001 and the fourth sensor 240C2 may be a Hall sensor including first and second input terminals and first and second output terminals.

The first and second input terminals of the third sensor 240C1 and the first and second input terminals of the fourth sensor 240C2 may be connected in parallel to each other, and the second driver 260 may supply a driving signal or power to the first and second input terminals of the third and fourth sensors 240C1 and 240C2 connected in parallel to each other.

The first and second output terminals of the third sensor 240C1 and the first and second output terminals of the fourth sensor 240C2 may be connected to each other in series, and a second output signal may be output from both ends of the first and second output terminals of the third and fourth sensors 240C1 and 240C2 connected to each other in series. The second output signal may be transmitted to the second driver 260.

In another embodiment, the output terminals of the first and second sensors may be provided independently of each other without being connected to each other and may output independent output signals. In addition, the output terminals of the third and fourth sensors may be provided independently of each other without being connected to each other and may output independent output signals.

In still another embodiment, the first OIS position sensor may include one position sensor (e.g., a Hall sensor or a driver IC including a Hall sensor), and transmit the output of the one position sensor to the driver 260.

The second OIS position sensor may include one position sensor (e.g., a Hall sensor or a driver IC including a Hall sensor), and transmit the output of the one position sensor to the driver 260.

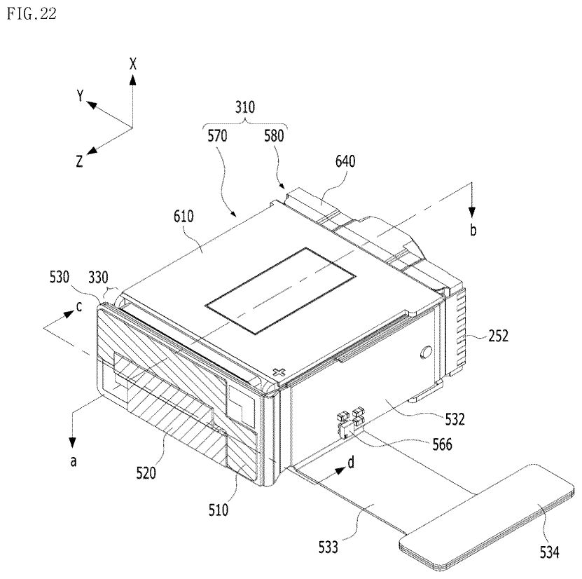

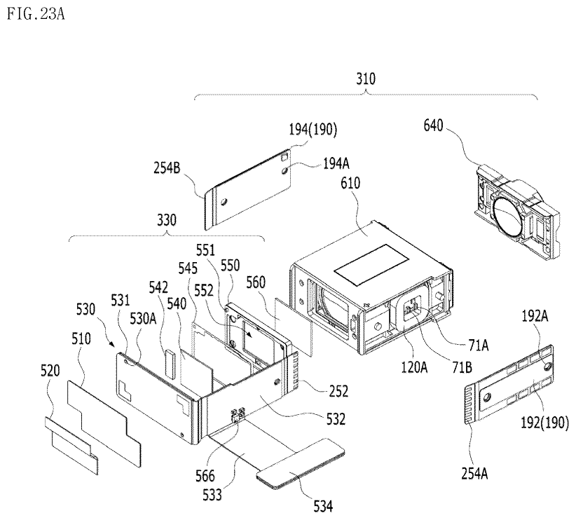

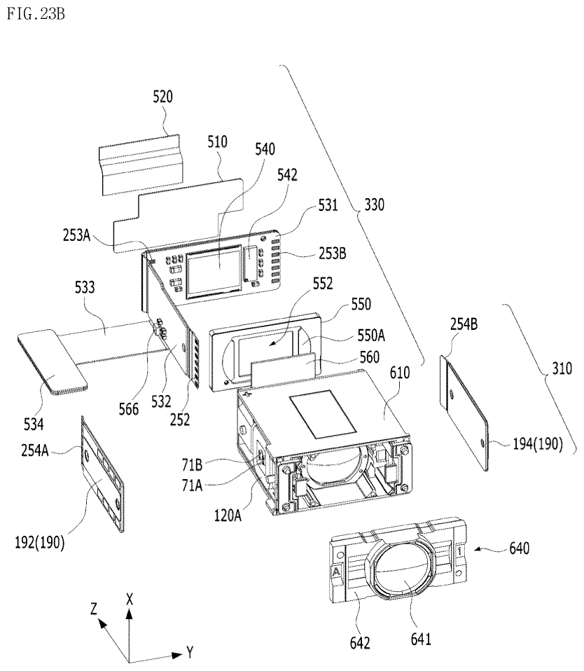

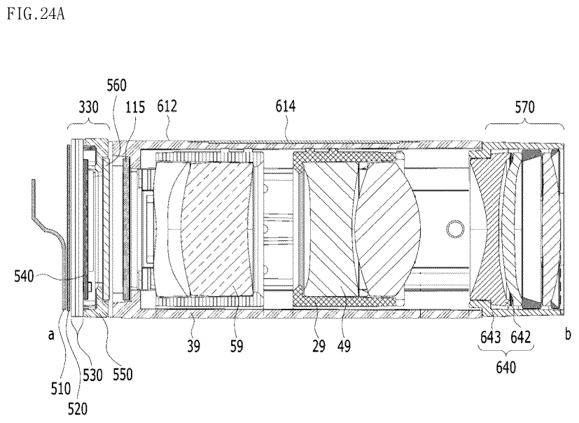

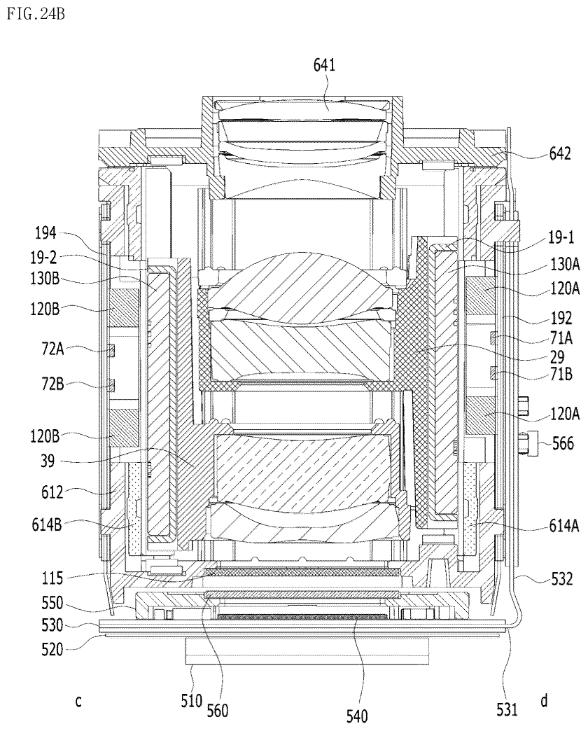

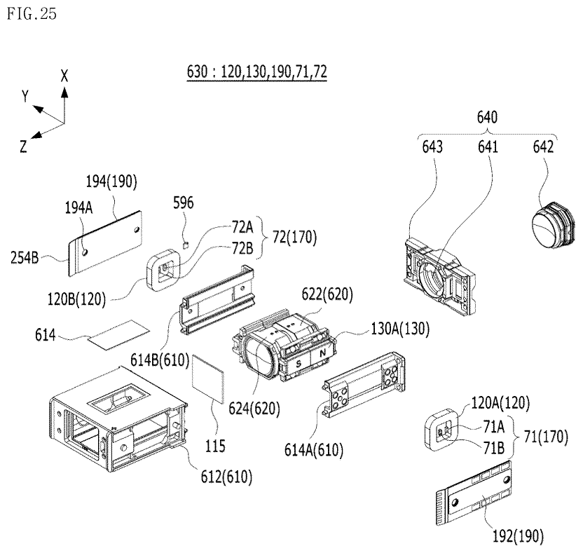

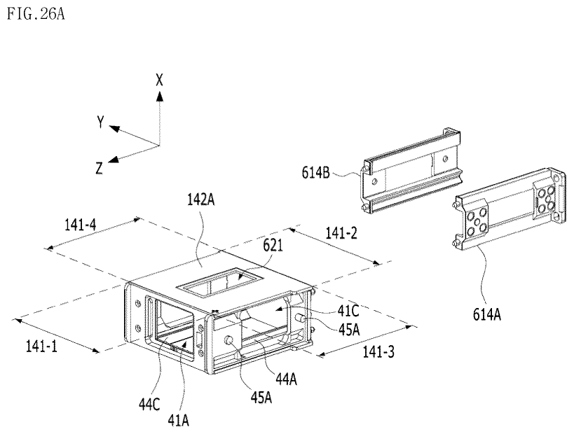

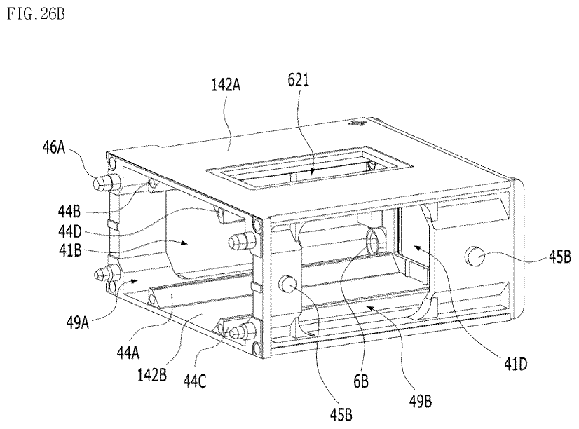

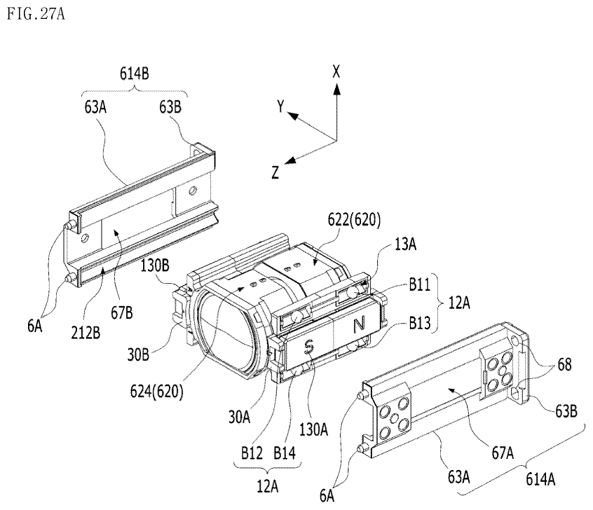

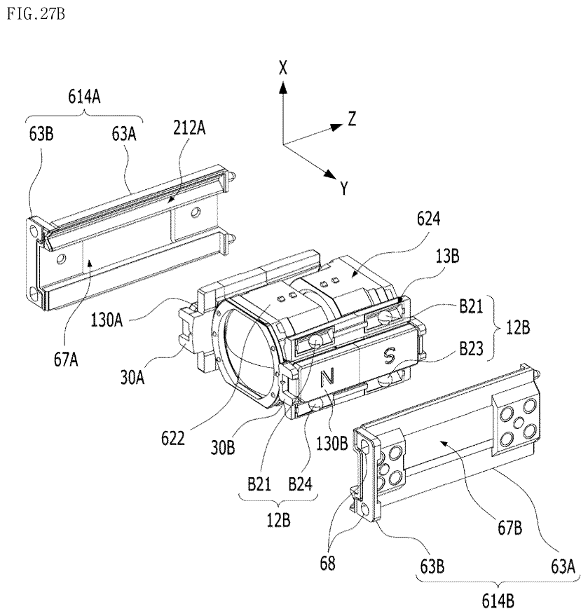

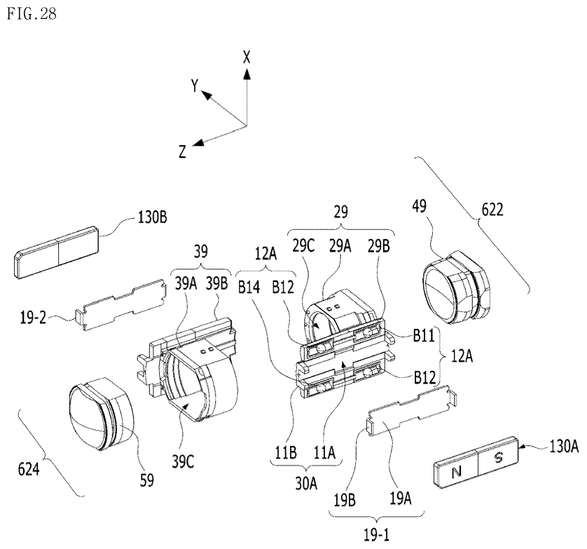

FIG. 22 is a perspective view of the first actuator 310 and the image sensing unit 330 according to the embodiment, FIG. 23A is a first exploded perspective view of the first actuator 310 and the image sensing unit 330 in FIG. 22, FIG. 23B is a second exploded perspective view of the first actuator 310 and the image sensing unit 330 in FIG. 22, FIG. 24A is a cross-sectional view of the first actuator 310 and the image sensing unit 330 taken along line ab in FIG. 22, FIG. 24B is a cross-sectional view of the first actuator 310 and the image sensing unit 330 taken along line cd in FIG. 22, FIG. 25 is an exploded perspective view of the first actuator 310, FIG. 26A is an exploded perspective view of a second housing 610, FIG. 26B is a perspective view of a body 612 of the second housing 610, FIG. 27A is a first perspective view of first and second guide parts 614A and 614B and a lens unit 620, FIG. 27B is a second perspective view of the first and second guide parts 614A and 614B and the lens unit 620, and FIG. 28 is an exploded perspective view of first and second magnets 130A and 130B and the lens unit 620.

Referring to FIGS. 22 to 28, the first actuator 310 may include a second housing 610, a lens unit 620 disposed in the second housing 610, and a first driving part 630 configured to move the lens unit 620 in the first direction (e.g., optical-axis direction or Z-axis direction).

The lens unit 620 may alternatively be referred to as a “lens assembly”. In an example, the lens unit 620 may include a plurality of lens assemblies.

Although the lens unit 620 is illustrated in FIG. 22 to 28 as including two lens assemblies 622 and 624, the disclosure is not limited thereto. In an example, the second lens assembly 622 and the third lens assembly 624 may be arranged in the first direction.

The first actuator 310 may further include a first lens assembly 640 disposed between the lens unit 620 and the second actuator 320. In an example, the first lens assembly 640 may be a fixed lens assembly that is fixed in position without moving in the optical-axis direction.

The first lens assembly 640 may include a first lens array 642 (or first lens group). In an example, the first lens assembly 640 may further include a lens barrel 641 coupled to the first lens array 642. In addition, the first lens assembly 640 may further include a third housing 643 coupled to the lens barrel 641. The third housing 643 may be disposed between the second housing 610 and the first housing 50, and may be coupled to at least one of the second housing 610 or the first housing 50.

In an example, at least one first coupling hole 643A may be formed in the front surface of the third housing 643 so as to be coupled to the at least one coupling protrusion 46A of the second housing 610. In addition, a second coupling hole may be formed in the rear surface of the third housing 643 so as to be coupled to the at least one coupling protrusion 52A of the first housing 50.

Although the first lens assembly 640 is described as being included in the first actuator 310, the disclosure is not limited thereto. The first lens assembly may not be included in the first actuator 310. In another embodiment, the first lens assembly 640 may be omitted.

In addition, in another embodiment, any one of 640, 622, and 624 may be referred to as a “first lens assembly”, another one of 640, 622, and 624 may be referred to as a “second lens assembly”, and the remaining one of 640, 622, and 624 may be referred to as a “third lens assembly”.

In the embodiment, for example, the first lens assembly 640 may be a fixed lens group, and each of the second lens assembly 622 and the third lens assembly 624 may be moving lens groups or lens groups.

In an example, the first lens assembly 640 may function as a focator that focuses parallel light to form an image at a specific position. In addition, the second lens assembly 622 may function as a variator that re-forms the image formed by the first lens assembly 640, which is a focator, at another position. Meanwhile, the second lens assembly 622 may greatly change in magnification due to a great change in a distance to a subject or an image distance. The second lens assembly 622, which is a variator, may play an important role in changing a focal length or magnification of an optical system. Meanwhile, the image point formed by the second lens assembly 622, which is a variator, may slightly vary depending on the position of the second lens assembly.

In addition, the third lens assembly 624 may perform position compensation on the image formed by the variator. In an example, the third lens assembly 624 may function as a compensator that accurately forms the image point formed by the second lens assembly 622, which is a variator, on the pixel of the image sensor 540.

For example, the second lens assembly 622 may be a zoom lens assembly performing a zoom function, and the third lens assembly 624 may be a focus lens assembly performing a focusing function.

Referring to FIGS. 26A and 26B, the second housing 610 may be disposed between the first housing 50 and the image sensor unit 330 (e.g., sensor base 550). The second housing 610 may alternatively be referred to as a “base” or a “holder”.

The second housing 610 may be disposed inside the cover member 300, and may have a polyhedral (e.g., rectangular parallelepiped) shape having a space defined therein in order to accommodate the lens unit 620 and the first driving part 630.

In an example, the second housing 610 may include a body 612, which includes an upper portion 142A (or upper plate), a lower portion 142B (or lower plate), and a plurality of side portions 141-1 to 141-4 disposed between the upper portion 142A and the lower portion 142B. The upper portion 142A of the second housing 610 may face the upper plate 301 of the cover member 300, and the side portions 141-1 to 141-4 may face the side plate 302 of the cover member 300.

The side portions 141-1 to 141-4 may alternatively be referred to as “side plates” or “sidewalls”. In an example, the first side portion 141-1 and the second side portion 141-2 may face each other or may be located opposite each other in the first direction, and the third side portion 141-3 and the fourth side portion 141-4 may face each other or may be located opposite each other in the third direction.

A first opening 41A (or first hole) may be formed in the first side portion 141-1 of the second housing 610 in order to expose one end of the lens unit 620, and a second opening 41B (or second hole) may be formed in the second side portion 141-2 of the second housing 610 in order to expose the other end of the lens unit 620.

In addition, a third opening 41C (or third hole) in which the first coil 120A is disposed or seated may be formed in the third side portion 141-3 of the second housing 610, and a fourth opening 41D (or fourth hole) in which the second coil 120B is disposed or seated may be formed in the fourth side portion 141-4 of the second housing 610. Each of the third and fourth openings 41C and 41D may have a through-hole shape, without being limited thereto. Each of the third and fourth openings may have a recess shape.

At least one first coupling protrusion 45A may be formed on the third side portion 141-3 of the second housing 610 so as to be coupled to the first circuit board 192 of the second board unit 190. In an example, the at least one first coupling protrusion 45A may protrude from the outer side surface of the third side portion 141-3.

At least one second coupling protrusion 45B may be formed on the fourth side portion 141-4 of the second housing 610 so as to be coupled to the second circuit board 194 of the second board unit 190. In an example, the at least one second coupling protrusion 45B may protrude from the outer side surface of the fourth side portion 141-4. In addition, at least one third coupling protrusion 46A may be formed on the second side portion 141-2 of the second housing 610.

The second housing 610 may include a first guide part 614A and a second guide part 614B. The first guide part 614A may support and guide the second lens assembly 622 when the lens unit 620 moves for zooming operation. The second guide part 614B may support and guide the third lens assembly 624 when the lens unit 620 moves for zooming operation.

The first guide part 614A may be disposed between the lens unit 620 and the third side portion 141-3, and the second guide part 614B may be disposed between the lens unit 620 and the fourth side portion 141-4.

In an example, the first guide part 614A may be coupled to the third side portion 141-3 of the second housing 610, and the second guide part 614B may be coupled to the fourth side portion 141-4 of the second housing 610.

Referring to FIGS. 27A and 27B, the first guide part 614A may include at least one first guide groove 212A. The second guide part 614B may include at least one second guide groove 212B. Here, the guide groove may alternatively be referred to as a “rail” or a “groove”.

In an example, each of the first guide part 614A and the second guide part 614B may include a body 63A and a protruding portion 63B protruding from the body 63A.

In an example, the first guide groove 212A may be formed in the inner side surface of the body 63A of the first guide part 614A, and the second guide groove 212B may be formed in the inner side surface of the body 63A of the second guide part 614B. In this case, the inner side surface of the body 63A of each of the first and second guide parts 614A and 614B may be a surface facing the lens unit 620.

In FIGS. 27A and 27B, one first guide groove 212A is formed in the upper side of the inner side surface of the body 63A of the first guide part 614A, and one second guide groove 212B is formed in the lower side of the inner side surface of the body 63A of the second guide part 614B. However, the disclosure is not limited thereto. In another embodiment, the guide groove may be formed in at least one of the upper side or the lower side of the inner side surface of the body of each of the first and second guide parts.

In an example, each of the first and second guide grooves 212A and 212B may be formed continuously from the front end of the inner side surface of the body 64A to the rear end thereof.

The protruding portion 63B of each of the first guide part 614A and the second guide part 614B may extend in a direction (e.g., third direction) perpendicular to the direction in which the first and second guide grooves extend (e.g., first direction). In an example, the protruding portion 63B of the first guide part 614A and the protruding portion 63B of the second guide part 614B may protrude in opposite directions.

In an example, the protruding portion 63B may be formed on the rear surface or rear end of each of the first guide part 614A and the second guide part 614B.

At least one hole 68 may be formed in the protruding portion 63B of each of the first and second guide parts 614A and 614B so as to be coupled to the rear end of the body 612 of the second housing 610. In an example, the hole 68 in the protruding portion 63B may be coupled to the coupling protrusion 46A of the body 612 of the second housing 610. In an example, the coupling protrusion 46A may be coupled to the first coupling hole 643A in the third housing 643 through the hole 68 in the protruding portion 63B.

At least one coupling protrusion 6A may be formed on the front surface or front end of each of the first guide part 614A and the second guide part 614B so as to be coupled to the body 612 of the second housing 610. In an example, a coupling hole 6B may be formed in the inner surface of the body 612 of the second housing 610 so as to be coupled to the coupling protrusion 6A of each of the first and second guide parts 614A and 614B (refer to FIG. 26B).

Referring to FIG. 26B, guide protrusions 44A to 44D may be formed on the inner surface of the body 612 of the second housing 610 in order to guide the first and second guide parts 614A and 614B. In an example, the first guide protrusion 44A may be disposed on the inner surface of the lower portion 142B of the second housing 610, and the second guide protrusion 44B may be disposed on the inner surface of the upper portion 142A of the second housing 610 so as to correspond to the first guide protrusion 44A in the second direction. The first guide part 614A may be disposed in a space 49A between the first and second guide protrusions 44A and 44B and the third side portion 141-3 of the second housing 610.

In addition, in an example, the third guide protrusion 44C may be disposed on the inner surface of the lower portion 142B of the second housing 610, and the fourth guide protrusion 44D may be disposed on the inner surface of the upper portion 142A of the second housing 610 so as to correspond to the third guide protrusion 44C in the second direction. The second guide part 614B may be disposed in a space 49B between the third and fourth guide protrusions 44C and 44D and the fourth side portion 141-4 of the second housing 610.

Due to the first to fourth guide protrusions 44A to 44D, the first and second guide parts 614A and 614B may be stably coupled to the body of the second housing 610, and the first and the second guide parts 614A and 614B may be prevented from deviating from the original positions thereof or colliding with the lens unit 620 due to impact.

The first guide part 614A may include a first opening 67A (or hole) formed therein so as to correspond to, face, or overlap the first magnet 130A. In an example, the first opening 67A may be located between the first magnet 130A and the first coil 120A.

The second guide part 614B may include a second opening 67B (or hole) formed therein so as to correspond to, face, or overlap the second magnet 130B. In an example, the second opening 67B may be located between the second magnet 130B and the second coil 120B. The electromagnetic force generated by interaction between the first magnet 130A and the first coil 120A and the electromagnetic force generated by interaction between the second magnet 130B and the second coil 120B may be increased by the first and second openings 67A and 67B.

In FIGS. 26A and 26B, the first and second guide parts 614A and 614B and the body 612 of the second housing 610 are formed as separate injection-molded products, and the separate injection-molded products are coupled to each other. However, the disclosure is not limited thereto. In another embodiment, the first and second guide parts and the body of the second housing may be formed as an integrated injection-molded product.

An opening 621 may be formed in the upper portion 142A of the body 612 of the second housing 610 in order to expose a portion of the lens unit 620, and the second housing 610 may further include a cover 614 covering the opening 621. In another embodiment, the opening 621 may not be formed, and the cover 614 may be omitted.

The lens unit 620 may include a second lens assembly 622 configured to move along the first guide part 614A and a third lens assembly 624 configured to move along the second guide part 614B.

Referring to FIGS. 27A, 27B, and 28, the second lens assembly 622 may include a first lens holder 29 and a second lens array 49 (or second lens group) disposed in the first lens holder 29. The lens holder may alternatively be referred to as a “bobbin”.

The second lens array 49 may include a single lens or a plurality of lenses.

The first lens holder 29 may include a first lens barrel 29A in which the second lens array 49 is disposed and a first support part 29B coupled to the first lens barrel 29A.

In an example, the first lens barrel 29A may have a barrel shape, and may include an opening 29C (or hole) formed therein, through which the second lens array 49 is coupled thereto.

The first side surface (or first surface) of the first support part 29B may be coupled to the first lens barrel 29A. The first support part 29B may correspond to, face, or overlap the body 63A of the first guide part 614A in the third direction.

A first seating portion 30A in which the first magnet 130A is disposed or seated may be formed in the second side surface (or second surface) of the first support part 29B. The second side surface (or second surface) of the first support part 29B may be a surface facing the first guide part 614A, and may be a surface opposite the first side surface (or first surface) of the first support part 29B.

In an example, the first seating portion 30A may include a first seating surface 11A formed in one region (e.g., central region) of the second side surface (or second surface) of the first support part 29B and at least one first support protrusion 11B protruding from the first seating surface 11A. In FIG. 18, the first seating portion 30A may include four first support protrusions formed on four corners of the second side surface of the first support part 29B, and the four first support protrusions may support the first magnet 130A. In another embodiment, the number of first support protrusions of the first seating portion may be one or two or more.

The first support part 29B may include at least one first groove 13A (or first guide groove) formed therein in order to accommodate at least a portion of a first rolling member 12A.

In an example, the at least one first groove 13A may correspond to, face, or overlap the at least one first guide groove 212A in the first guide part 614A.

In an example, two first grooves may be formed above the seating surface 11A of the first seating portion 30A so as to be spaced apart from each other, and two first grooves may be formed below the seating surface 11B so as to be spaced apart from each other. In another embodiment, the two grooves formed above or below the seating surface 11B may be connected to each other to form one groove. In an example, the number of grooves may be identical to the number of balls B11 to B14. However, the disclosure is not limited thereto.

The third lens assembly 624 may include a second lens holder 39 and a third lens array 59 (or third lens group) disposed in the second lens holder 39.

The third lens array 59 may include a single lens or a plurality of lenses.

The plurality of lenses included in each of the second and third lens arrays 49 and 59 may be sequentially disposed or arranged in the first direction. In an example, each of the second and third lens arrays 49 and 59 may include various types of optical lenses. In an example, each of the second and third lens arrays 49 and 59 may include at least one of a front lens having positive power or a rear lens having negative power.

A distance between the second lens group and the third lens group in the optical-axis direction may be changed by the first driving part 630.

The second lens holder 39 may include a second lens barrel 39A in which the third lens array 59 is disposed and a second support part 39B coupled to the second lens barrel 39A.

In an example, the second lens barrel 39A may have a barrel shape, and may include an opening 39C (or hole) formed therein, through which the second lens array 49 is coupled thereto.

The first side surface (or first surface) of the second support part 39B may be coupled to the second lens barrel 39A. The second support part 39B may correspond to, face, or overlap the body 63A of the second guide part 614B in the third direction.

A second seating portion 30B in which the second magnet 130B is disposed or seated may be formed in the second side surface (or second surface) of the second support part 39B. The second side surface (or second surface) of the second support part 39B may be a surface facing the second guide part 614B, and may be a surface opposite the first side surface (or first surface) of the second support part 39B.

In an example, the second seating portion 30B may include a second seating surface formed in one region (e.g., central region) of the second side surface (or second surface) of the second support part 39B and at least one second support protrusion protruding from the second seating surface. The description of the first seating surface 11A and the first support protrusion 11B of the first support part 29B may be equally or similarly applied to the second seating surface and the second support protrusion of the second support part 29B.

The second support part 39B may include at least one second groove 13B (or second guide groove) formed therein in order to accommodate at least a portion of a second rolling member 12B.

In an example, the at least one second groove 13B may correspond to, face, or overlap the at least one second guide groove 212B in the second guide part 614B. The description of the first groove 13A in the first support part 30A may be equally or similarly applied to the second groove 13B in the second support part 30B.

Each of the first and second guide grooves 212A and 212B and the first and second grooves 13A and 13B may have a V or U shape. However, the disclosure is not limited thereto. Each groove may be shaped so as to be in contact at two or more points thereof with the balls B11 to B14 and B21 and B24. When the second and third lens assemblies 622 and 624 move, decentering or tilt thereof may be prevented by the first and second guide grooves 212A and 212B and the first and second grooves 13A and 13B. Accordingly, the plurality of lens arrays may be well aligned with each other, whereby the occurrence of change in angle of view or defocusing may be prevented, with a result that the image quality or the resolution of the camera device 200 may be greatly improved.

The first actuator 310 may further include rolling members 12A and 12B disposed between the second housing 610 and the lens unit 620. In an example, the rolling members 12A and 12B may be disposed between the guide parts 614A and 614B of the second housing 610 and the grooves 13A and 13B in the support parts 39A and 39B of the lens unit 620.

The rolling member may alternatively be referred to as a “ball member”, a “ball”, or a “ball bearing”. In an example, each of the rolling members 12A and 12B may include at least one ball.

The rolling members 12A and 12B may be in contact with the second housing 610 and the lens unit 620, and may support the lens unit 620. When the lens unit 620 moves in the first direction, the rolling members 12A and 12B may perform rolling motion between the lens unit 620 and the second housing 610, thereby reducing friction between the lens unit 620 and the second housing 610. That is, due to the rolling motion of the rolling members 12A and 12B, the lens unit 620 may slide in the first direction along the first and second guide parts 614A and 614B in a state of contacting the rolling members 12A and 12B.

In an example, the rolling members may include a first rolling member 12A and a second rolling member 12B. The first rolling member 12A may be disposed between the first guide part 614A of the second housing 610 and the second lens assembly 622 (e.g., first support part 29B). The second rolling member 12B may be disposed between the second guide part 614B of the second housing 610 and the third lens assembly 624 (e.g., second support part 39B).

The first rolling member 12A may include a plurality of balls B11 to B14, and the second rolling member 12B may include a plurality of balls B21 to B24. Each of the balls B11 to B14 and B21 to B24 may be made of metal, plastic, or resin. However, the disclosure is not limited thereto. Each of the balls B11 to B14 and B21 to B24 may have a circular shape, and may have a diameter large enough to support movement of the lens unit 620.

Next, the first driving part 630 will be described.

The first driving part 630 may move the second lens assembly 622 in the first direction, and may move the third lens assembly 624 in the first direction.

In an example, the first driving part 630 may move at least one lens group, e.g., the second lens group or the third lens group, in the first direction or the optical-axis direction.

The first driving part 630 may include a magnet 130 disposed in the lens unit 620 and a coil 120 disposed in the second housing 610.

In an example, the magnet 130 may include a first magnet 130A disposed on the second lens assembly 622 and a second magnet 130B disposed on the third lens assembly 624.

In an example, the first magnet 130A may be disposed on the first lens holder 29 of the second lens assembly 622, and the second magnet 130B may be disposed on the second lens holder 39 of the third lens assembly 624.

In an example, the first magnet 130A may be disposed in the first seating portion 30A of the first support part 29B of the first lens holder 29, and the second magnet 130B may be disposed in the second seating portion 30B of the second support part 39B of the second lens holder 39.

For example, each of the first and second magnets 130A and 130B may be a monopolar-magnetized magnet including one N pole and one S pole. In another embodiment, each of the first and second magnets 130A and 130B may be a bipolar-magnetized magnet including two N poles and two S poles.

The coil 120 may include a first coil 120A disposed on the third side portion 142-3 of the second housing 610 so as to correspond to, face, or overlap the first magnet 130A in the third direction and a second coil 120B disposed on the fourth side portion 142-4 of the second housing 610 so as to correspond to, face, or overlap the second magnet 130B in the third direction.

For example, each of the first coil 120A and the second coil 120B may have a closed curve or ring shape including a cavity (or hole). For example, each of the first coil 120A and the second coil 120B may be formed in a shape of a coil ring wound in the clockwise or counterclockwise direction with respect to (or about) the third axis parallel to the third direction.

In an example, the N pole and the S pole of the first magnet 130A may be disposed so as to face the first coil 120A, and the N pole and the S pole of the second magnet 130B may be disposed so as to face the second coil 120B. In an example, the cavity or the hole in each of the first and second coils 120A and 120B may face the first and second magnets 130A and 130B in the third direction.

The first driving signal (e.g., first current) may be applied to the first coil 120A, and the second driving signal (e.g., second current) may be applied to the second coil 120B.

The first lens assembly 622 may be moved in the first direction by the electromagnetic force generated by interaction between the first coil 120A and the first magnet 130A. In addition, the second lens assembly 624 may be moved in the first direction by the electromagnetic force generated by interaction between the second coil 120B and the second magnet 130B.

Movement of each of the first lens assembly 622 and the second lens assembly 624 may be controlled by controlling the first driving signal and the second driving signal. As the movement of each of the first lens assembly 622 and the second lens assembly 624 is controlled, the position (or displacement) of each of the first lens assembly 622 and the second lens assembly 624 may be controlled, and accordingly, zooming and autofocus of the camera device 200 may be performed.

Referring to FIG. 18, the first driving part 630 may further include a first yoke 19-1 disposed on the first lens holder 29 and a second yoke 19-2 disposed on the second lens holder 39. The first yoke 19-1 may increase the electromagnetic force generated by interaction between the first magnet 130A and the first coil 120A, and the second yoke 19-2 may increase the electromagnetic force generated by interaction between the second magnet 130B and the second coil 120B. The first and second yokes 19-1 and 19-2 may improve driving force for moving the lens unit 620, thereby reducing power consumption.

In an example, the first yoke 19-1 may be disposed between the first magnet 130A and the first lens holder 29, and the second yoke 19-2 may be disposed between the second magnet 130B and the second lens holder 39. In an example, the first yoke 19-1 may be disposed in the first seating portion 30A of the first support part 29B, and the second yoke 19-2 may be disposed in the second seating portion 30B of the second support part 39B.

In an example, the first yoke 19-1 may include a first portion 19A disposed on the first seating surface 11A so as to face the first magnet 130A in the third direction and a second portion 19B extending from at least one of one end or the other end of the first portion 19A. In an example, the second portion 19B may include a 2-1^{st} portion supporting one end of the first magnet 130A and a 2-2^{nd} portion supporting the other end of the first magnet 130A.

The first driving part 630 may further include a second board unit 190 conductively connected to the first coil 120A and the second coil 120B. For example, the second board unit 190 may be a printed circuit board.

The second board unit 190 may be disposed on the second housing 610. In an example, the second board unit 190 may include a first circuit board 192 disposed on the third side portion 142-3 of the second housing 610 and a second circuit board 194 disposed on the fourth side portion 142-4 of the second housing 610. In an example, the first circuit board 192 may include at least one hole 192A formed therein so as to be coupled to the at least one first coupling protrusion 45A of the second housing 610, and the second circuit board 194 may include at least one hole 194A formed therein so as to be coupled to the at least one second coupling protrusion 45B of the second housing 610.

The first coil 120A may be disposed or mounted on the first surface of the first circuit board 192. In this case, the first surface of the first circuit board 192 may be a surface facing the third side portion 142-3 of the second housing 610 in the third direction. The second coil 120B may be disposed or mounted on the first surface of the second circuit board 194. In this case, the first surface of the second circuit board 194 may be a surface facing the fourth side portion 142-4 of the second housing 610 in the third direction.

The first circuit board 192 may be conductively connected to the first coil 120A. In an example, two pads, which are conductively connected to the first coil 120A, may be formed on the first surface of the first circuit board 192.

In addition, the first circuit board 192 may include a plurality of terminals 254A. In an example, the plurality of terminals 254A may be formed on the second surface of the first circuit board 192. In an example, the second surface of the first circuit board 192 may be a surface opposite the first surface of the first circuit board 192. In an example, two terminals among the plurality of terminals 254A may be conductively connected to the two pads of the first circuit board 192 connected to the first coil 120A, and may be conductively connected to the first coil 120A.

The second circuit board 194 may be conductively connected to the second coil 120B. In an example, two pads, which are conductively connected to the second coil 120B, may be formed on the first surface of the second circuit board 194. In addition, the second circuit board 194 may include a plurality of terminals 254B.

In an example, the plurality of terminals 254B may be formed on the second surface of the second circuit board 194. In an example, the second surface of the second circuit board 194 may be a surface opposite the first surface of the second circuit board 194. Although the terminals 254B are not illustrated in detail in FIG. 25, the terminals 254B may be formed on the second surface of the second circuit board 194 in the same form as the terminals 254A of the first circuit board 192.

In an example, two terminals among the plurality of terminals 254B may be conductively connected to the two pads of the second circuit board 194 connected to the second coil 120B, and may be conductively connected to the second coil 120B.

The second driving part 70 may include a first position sensor unit 170 in order to perform feedback driving for accurate zooming and AF operation.

The first position sensor unit 170 may include a first position sensing part 71 configured to detect the position or displacement of the second lens assembly 622 and a second position sensing part 72 configured to detect the position or displacement of the third lens assembly 624.

In an example, the first position sensing part 71 may be disposed or mounted on the first circuit board 192, and may be conductively connected to the first circuit board 192. The second position sensing part 72 may be disposed or mounted on the second circuit board 194, and may be conductively connected to the second circuit board 194.

In an example, the first position sensing part 71 may be disposed or mounted on the first surface of the first circuit board 192, and the second position sensing part 72 may be disposed or mounted on the first surface of the second circuit board 194. In an example, the first position sensing part 71 may be disposed in the cavity in the first coil 120A, and the second position sensing part 72 may be disposed in the cavity in the second coil 120B.

In an example, the first position sensing part 71 may face or overlap the first magnet 130A in the third direction. In an example, the first position sensing part 71 may be disposed opposite the first magnet 130A.

The first position sensing part may detect the magnetic field intensity of the first magnet 130A. In an example, the first position sensing part 71 may detect movement of the first magnet 130A in the optical-axis direction.

The second position sensing part 72 may face or overlap the second magnet 130B in the third direction. In an example, the second position sensing part 72 may be disposed opposite the second magnet 130B.

The second position sensing part may detect the magnetic field intensity of the second magnet 130B. In an example, the second position sensing part 72 may detect movement of the second magnet 130B in the optical-axis direction.

In an example, the first position sensing part 71 may include a first sensor 71A and a second sensor 71B. For example, each of the first and second sensors 71A and 71B may be a Hall sensor. In an example, the first sensor 71A and the second sensor 71B may be arranged so as to be spaced apart from each other in the first direction.

In an example, the second position sensing part 72 may include a third sensor 72A and a fourth sensor 72B. For example, each of the third and fourth sensors 72A and 72B may be a Hall sensor. In an example, the third sensor 72A and the fourth sensor 72B may be arranged so as to be spaced apart from each other in the first direction.

In FIG. 25, each of the first position sensing part 71 and the second position sensing part 72 includes two sensors. However, in another embodiment, each of the first position sensing part and the second position sensing part may include one sensor. In this case, the sensor may be a Hall sensor or a driver IC including a Hall sensor.

The camera device 200 may include a memory 596 disposed on the second board unit 190. For example, the memory 596 may be a non-volatile memory, such as electrically erasable PROM (EEPROM).

In an example, the memory 596 may be disposed or mounted on the second circuit board 194, and may be conductively connected to the second circuit board 194.

For example, the memory 596 may store data necessary for driving of the driving part. In this case, the driving part may include at least one of the first driving part 630 or the second driving part 70. In an example, the memory 596 may store at least one of data of the first position sensing part 71 corresponding to the movement range of the second lens group or data of the second position sensing part 72 corresponding to the movement range of the third lens group.

In this case, the data of the first position sensing part 71 may be data (or reference code value) related to the output of the first position sensing part 71 corresponding to the movement range of the second lens group acquired through calibration. In addition, the data of the second position sensing part 72 may be data (or reference code value) related to the output of the second position sensing part 72 corresponding to the movement range of the third lens group acquired through calibration.

In addition, the memory 596 may store data of the first OIS position sensors 240A and 240B corresponding to the second-axis (X-axis) tilt range of the OIS moving unit. In this case, the data of the first OIS position sensors 240A and 240B may be a reference code value related to the output of the first OIS position sensors 240A and 240B corresponding to the second-axis (X-axis) tilt range of the OIS moving unit acquired through calibration.

In addition, the memory 596 may store data of the second OIS position sensor 240C corresponding to the third-axis (Y-axis) tilt range of the OIS moving unit. In this case, the data of the second OIS position sensor 240C may be a reference code value related to the output of the second OIS position sensor 240C corresponding to the third-axis (Y-axis) tilt range of the OIS moving unit acquired through calibration.

In an example, the memory 596 may be conductively connected to at least one of the plurality of terminals 254B of the second circuit board 194.

The camera device 200 may further include a temperature sensor 566 disposed on the second board unit 190. In an example, the temperature sensor 566 may measure temperature of the camera device 200 or ambient temperature of the camera device 200, and may output temperature information corresponding to the result of the measurement.

Referring to FIG. 25, the first actuator 310 may further include a glass 115 disposed in front of the lens unit 620. In an example, the glass 115 may be disposed in the second housing 610 so as to cover the first opening 41A in the second housing 610, and may protect the lens unit 620 and may prevent foreign substances from entering the second housing.

The image sensing unit 330 may include an image sensor 540 configured to receive and detect light that has passed through the optical member 40 of the second actuator 320 and the lens assemblies 640, 622, and 624 of the first actuator 310 and to convert the detected light into an electrical signal.

In an example, the image sensor 540 may include an imaging area for detecting light. Here, the imaging area may alternatively be referred to as an effective area, a light-receiving area, or an active area. In an example, the imaging area may include a plurality of pixels on which an image is formed.

The image sensing unit 330 may include a third board unit 530 conductively connected to the image sensor 540. The third board unit 530 may be disposed so as to be spaced apart from the second housing 610. For example, the third board unit 530 may alternatively be referred to as a sensor board unit.

With respect to the second housing 610, the first board unit 250 may be disposed in front of the second housing 610, the third board unit 530 may be disposed behind the second housing 610, and the second board unit 190 may be disposed on the side of the second housing 610.

In an example, the second board unit 190 may be disposed on a first side (e.g., left or right) of the second housing 610. In an example, the first circuit board 192 may be disposed on the first side of the second housing 610, and the second circuit board 194 may be disposed on a third side of the second housing 610. The third board unit 530 may be disposed on a second side (e.g., rear side) of the second housing 610. In addition, the first board unit 250 may be disposed on a fourth side of the second housing 610. The first side and the third side may be located opposite each other, and the second side and the fourth side may be located opposite each other.

The third board unit 530 may include a first board 531, on which the image sensor 540 is disposed or mounted. In an example, the image sensor 540 may be disposed on a first surface of the first board 531, and the first surface of the first board 531 may be a surface facing the first actuator 310 or the lens unit 620. The first board 531 may alternatively be referred to as a “sensor board”.

The first board 531 may include a plurality of first terminals 253A and a plurality of second terminals 253B. In an example, the plurality of first terminals 253A may be disposed between the image sensor 540 and a first end portion of the first board 531, and the plurality of second terminals 253B may be disposed between the image sensor 540 and a second end portion of the first board 531. The first end portion may be located opposite the second end portion.

In an example, the plurality of first terminals 253A may correspond to, face, or overlap the plurality of terminals 254A of the first circuit board 192 in the first direction, and may be conductively connected to the plurality of terminals 254A of the first circuit board 192 by means of solder or a conductive adhesive.

In an example, in order to facilitate soldering, an end portion (or first end) or a terminal portion of the first circuit board 192, on which the plurality of terminals 254A is formed, may include a bent or curved portion. In an example, the terminal portion of the first circuit board 192, on which the plurality of terminals 254A is formed, may be an inclined portion that is curved or bent inwardly.

In an example, the plurality of second terminals 253B may correspond to, face, or overlap the plurality of terminals 254B of the second circuit board 194 in the first direction, and may be conductively connected to the plurality of terminals 254B of the second circuit board 194 by means of solder or a conductive adhesive.

In an example, in order to facilitate soldering, an end portion (or first end) or a terminal portion of the second circuit board 194, on which the plurality of terminals 254B is formed, may include a bent or curved portion. In an example, the terminal portion of the second circuit board 194, on which the plurality of terminals 254B is formed, may be an inclined portion that is curved or bent inwardly.

The third board unit 530 may include a second board 532, which is connected to the first board 531 and extends in the first direction. The second board 532 may include a plurality of terminals 252. The first board unit 250 may be conductively connected to the third board unit 530. In an example, the plurality of terminals 252 of the second board 532 may be conductively connected to the plurality of terminals 251 of the first circuit board 250A of the first board unit 250 by means of a conductive adhesive or solder.

In an example, referring to FIGS. 22, 23A, and 23B, the second board 532 may be disposed so as to face the first circuit board 192 in the third direction, and may be disposed on the second surface of the first circuit board 192. In an example, the third board unit 530 may include a bent portion between the first board 531 and the second board 532.

The third board unit 530 may include a connector 534 including a port or a socket in order to be conductively connected to an external device. In an example, the port or the socket may be formed on at least one of the upper portion (upper surface) or lower portion (lower surface) of the connector.

In addition, the third board unit 530 may further include a third board 533 connecting the second board 532 to the connector 534. The third board unit 530 may be a printed circuit board. For example, each of the first to third boards 531, 532, and 533 may include at least one of a rigid substrate or a flexible substrate.

In another embodiment, at least one of the second board 532 or the connector 534 may be omitted, and the port or the socket may be formed on the first board. In still another embodiment, the port or the socket may be formed on at least one of the first to third boards.

The image sensing unit 330 may further include a first driver 542 disposed on the third board unit 530. The first driver 542 may be disposed or mounted on the first board 531. In an example, the first driver 542 may be disposed between the image sensor 540 and the plurality of second terminals 253B. Each of the first driver 542 and the second driver 260 may alternatively be referred to as a “controller”. In addition, in an example, each of the first and second drivers 542 and 260 may include a storage unit or a memory.

The third board unit 530 may be provided with a circuit element, a passive element, an active element, or a circuit pattern.

The image sensing unit 330 may further include a sensor base 550 disposed between the third board unit 530 and the first actuator and a filter 560 disposed on the sensor base 550. In an example, the sensor base 550 may be disposed between the first board 531 of the third board unit 530 and the second housing 610.

The sensor base 550 may be coupled, attached, or fixed to the first surface of the first board 531 by means of an adhesive 545. The lower portion or lower surface of the sensor base 550 may be coupled to the first surface of the first board 531 by means of the adhesive 545.

In an example, at least one coupling protrusion 551 may be formed on the lower surface or lower end of the sensor base 550, and at least one hole 530A may be formed in the first board 531 so as to be coupled to the at least one coupling protrusion 551.

The sensor base 550 may include a seating portion 550A in which the filter 560 is disposed or seated. In an example, the seating portion 550A may be formed in the first surface of the sensor base 550. The first surface of the sensor base 550 may be a surface facing the second housing 610 in the first direction. In an example, the seating portion 550A may be formed in a shape of a recess, a cavity, or a hole depressed in the first surface of the sensor base 550. However, the disclosure is not limited thereto. In another embodiment, the seating portion may be formed in a shape of a protruding portion protruding from the first surface of the sensor base 550. The sensor base 550 may alternatively be referred to as a “holder”.

The filter 560 may be disposed in the seating portion 550A of the sensor base 550. In an example, the seating portion 550A of the sensor base 550 may include an inner side surface and a bottom surface, and the filter 560 may be disposed on the bottom surface of the seating portion 550A of the sensor base 550.

The sensor base 550 may include an opening 552 (or through-hole) formed therein to allow light that has passed through the filter 560 to be introduced into the image sensor 540. The opening 552 may correspond to, face, or overlap the image sensor 550 (e.g., imaging area). In an example, the opening 552 may be formed in the bottom surface of the seating portion 550A. The area of the opening 552 may be smaller than the area of the upper surface or lower surface of the filter 560. However, the disclosure is not limited thereto.

The filter 560 may serve to block introduction of light within a specific frequency band, among the light that has passed through the lens unit 620, into the image sensor 540. The filter 560 may be, for example, an infrared cut filter, without being limited thereto. In an example, the filter 560 may be disposed parallel to an xy-plane perpendicular to the first direction. In an example, the filter 560 may be attached to the bottom surface of the seating portion 550A of the sensor base 550 by means of an adhesive member (not shown) such as UV epoxy. The filter 560 and the image sensor 540 may be spaced apart from each other so as to face each other in the first direction.

The image sensing unit 330 may further include a reinforcing member 510 disposed on the third board unit 530. In an example, the reinforcing member 510 may be disposed on the second surface of the first board 531, and the second surface of the first board 531 may be a surface opposite the first surface of the first board 531.

The reinforcing member 510 may be formed of a conductive material having high thermal conductivity, for example, a metallic material. For example, the reinforcing member 510 may be formed of SUS, aluminum, etc., without being limited thereto.

In addition, the reinforcing member 510 may be conductively connected to a ground terminal of the third board unit 530, thereby serving as a ground for protecting the camera device 200 from electrostatic discharge (ESD).

The image sensing unit 330 may further include a heat dissipation member 520 disposed on or attached to the reinforcing member 510. In an example, the heat dissipation member 52 may be attached to at least one of the first board 531 or the reinforcing member 510, and may perform a heat dissipation function.

The embodiment in FIGS. 22 to 28 includes a zoom lens assembly 622 that performs a zoom function and a focus lens assembly 624 that performs an autofocus function, but in other embodiments the zoom lens assembly 622 may be omitted and the focus lens assembly 624 is included in other embodiments. For example, the first actuator according to another embodiment may be a fixed zoom actuator that performs an autofocus function.

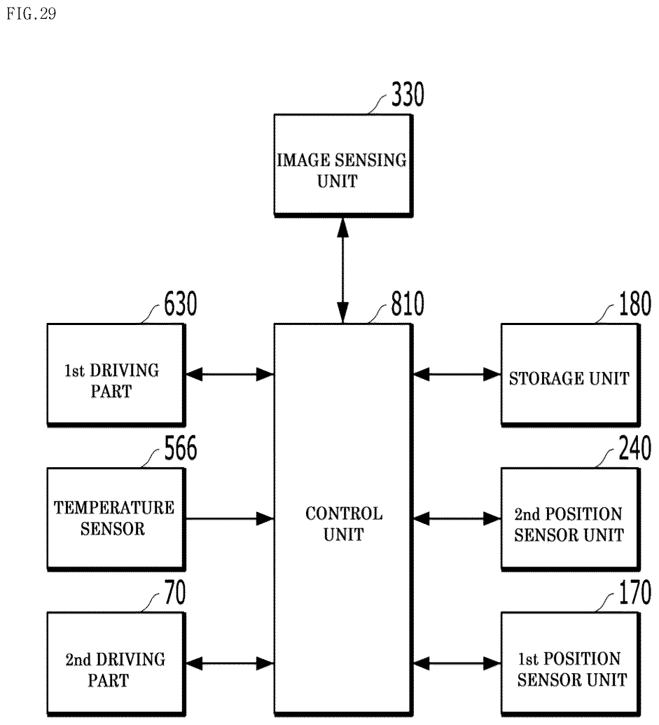

FIG. 29 is a functional block diagram of the camera device 200 according to the embodiment.

Referring to FIG. 29, the camera device 200 may include a first driving part 630, a second driving part 70, a first position sensor unit 170, a second position sensor unit 240, a storage unit 180, an image sensing unit 600 and a control unit 810.

The first driving part 630 is configured to receive a first driving signal, apply the received first driving signal to the first coil 120A, and move the second lens assembly 622 in the first direction by an interaction between the first coil 120A and the first magnet 130A.

Additionally, the first driving part 630 is configured to receive a second drive signal, apply the received second drive signal to the second coil 120B, and move the third lens assembly 624 in the first direction by an interaction between the second coil 120B and the second magnet 130B.

The second driving part 70 is configured to receive a first OIS driving signal, apply the received first OIS driving signal to the first OIS coils 230A and 230B, and rotate the OIS moving part (e.g., holder 30) by a preset angle with respect to the second axis (e.g., X-axis) as the rotation axis by an interaction between the first OIS coils 230A and 230B and the first OIS coils 230A and 230B.

In addition, the second driving part 70 is configured to receive a second OIS driving signal, apply the received second OIS driving signal to the second OIS coil 230C, and rotate the OIS moving unit (e.g., holder 30) by a preset angle with respect to the third axis (e.g., Y-axis) as the rotation axis by an interaction between the second OIS coil 230C and the second OIS magnet 32.

The second driving part 70 is configured to move the holder 30 coupled to the optical member 40 so that a path of light incident on the optical member 40 can move on a plane (e.g., XY plane) perpendicular to the first axis (optical axis or Z axis). As a result, the image formed on the image sensor 540 can be moved in the X-axis direction and/or Y-axis direction. That is, by controlling the movement of the holder 30, in the embodiment blurring of the image or shaking of the video due to shaking of the camera device when capturing an image or video due to the user's hand shaking can be corrected.

The first position sensor unit 170 is configured to receive a first driving signal DI1 and supply the received first driving signal DI1 to the first sensor 71A and the second sensor 71B. The first position sensor unit 170 is configured to receive a second driving signal DI2 and supply the received second driving signal DI2 to the third sensor 72A and the fourth sensor 72B.

The first position sensor unit 170 is configured to detect a displacement of the second lens assembly 622 and outputs a first output signal V1 according to the detection result. Additionally, the first position sensor unit 170 is configured to detect a displacement of the third lens assembly 624 and outputs a second output signal V2 according to the detection result.

The second position sensor unit 240 is configured to supply a driving signal to each of the first and second sensors 240A and 240B of the first OIS position sensor and the second OIS position sensor 240C.

The first OIS position sensor 240A and 240B can detect the displacement of the holder 30 in the third axis direction and output an output signal according to the detected result. The second OIS position sensor 240C can detect the displacement of the holder 30 in the second axis direction and output an output signal according to the detected result.

The storage unit 180 is configured to store data necessary to operate the camera device 200. The storage unit 180 may be alternatively expressed as “memory.” For example, the storage unit 180 may store information about the zoom position and focus position corresponding to the distance to the subject.

For example, the storage unit 180 may store a first reference code value (or data) corresponding to the first output signal V1 of the first position sensing unit 71 which corresponds to the movement range (or stroke range or displacement) of the second lens assembly 622. In addition, the storage unit 180 may store a second reference code value (or data) corresponding to the second output signal V2 of the second position sensing unit 72 which corresponds to the movement range (or stroke range or displacement) of the third lens assembly 624. The first and second reference code values may be values previously stored in the storage unit 180 through calibration.

The storage unit 180 may be a separate component from the control unit 810, but is not limited thereto, and may be included in the control unit 810 in other embodiments. For example, the storage unit 180 may be included in at least one of the first driver 542 and the second driver 260.

For example, the camera device 200 may be accurately focused based on a target position of the second lens assembly 622 and a target position of the third lens assembly 624.

The image sensing unit 330 may include an image sensor 540 that converts light reflected from the subject into an electrical signal. For example, the image sensor 540 may include a light receiving unit that receives light and converts it into an electrical signal and an analog-to-digital converter that converts the converted electrical signal into a digital signal. Also, for example, the image sensor 540 may further include an image signal processor that performs signal processing on digital signals.

The control unit 810 controls the overall operation of the camera device 200. For example, the control unit 200 may control the first position sensor unit 170 and the second position sensor unit 240 to provide an anti-shake function, an autofocus function, and a magnification adjustment function. And the control unit 810 can drive the first driving part 630 and the second driving part 70. For example, the control unit 810 may include a first driver 542 and a second driver 260. For example, each of the first driver 542 and the second driver 260 may include at least one of an analog-to-digital converter, an amplifier, a PID controller, or a memory.

The first driver 542 is configured to receive the output signal of the first position sensor unit 170, generate a first code value according to the result of analog-to-digital conversion of the received output signal, and control the driving signal applied to the first coil 120 of the first driving part 630 based on the result of comparing the generated first code value and the target value. For example, the first target value may be a reference code value corresponding to a target zoom position of the second lens assembly 622.

The second driver 260 is configured to receive the output signal of the first OIS position sensor 240A, 240B of the second position sensor unit 240, generate a second code value according to the result of analog-to-digital conversion of the received output signal, and control the first driving signal applied to the first OIS coils 230A and 230B of the second driving part 70 based on the result of comparing the generated second code value and a second target value.

In addition, the second driver 260 is configured to receive the output signal of the second OIS position sensor 240C of the second position sensor unit 240, generate a third code value according to the result of analog-to-digital conversion of the received output signal, and control the second driving signal applied to the second OIS coil 230C of the second driving part 70 based on the result of comparing the generated third code value and a third target value.

For example, the second target value is a reference code value (or data) corresponding to the output of the first OIS position sensor 240A and 240B which corresponds to a second axis (X-axis) target tilting position of the OIS moving unit of the second actuator 320. Also, for example, the third target value is a reference code value (or data) corresponding to the output of the second OIS position sensor 240C which corresponds to a third axis (Y-axis) target tilting position of the OIS moving unit of the second actuator 320. The reference code value (or data) for the output of each of the first OIS position sensors 240A and 240B and the second OIS position sensor 240C may be set in advance through calibration and stored in the storage unit 180.

The camera device 200 may further include a temperature sensor 566 for temperature compensation. The temperature sensor 566 may output temperature information corresponding to the result of measurement of the temperature of the camera device 200.

The temperature information from the temperature sensor 566 may be used for temperature compensation for focusing operation of the third lens assembly 624. In an example, the storage unit 180 may store a compensation value corresponding to the temperature information.

For example, since the second lens assembly 622, which is responsible for zooming, moves according to the magnification set by the user, it is possible to perform temperature compensation on the third lens assembly 624, which is responsible for autofocus, in a state (or condition) in which the position of the second lens assembly 622 is fixed.

Also, for example, the control unit 810 is configured to receive temperature information from the temperature sensor 566, obtain a compensation value for temperature compensation corresponding to the received temperature information, and control the driving signal of the second coil 120B of the third lens assembly 624 based on the obtained compensation value. Because of this, in the embodiment, an accurate auto-focusing operation reflecting temperature compensation can be performed.

In addition, the camera device 200 according to the embodiment may be included in an optical instrument for the purpose of forming an image of an object present in a space using reflection, refraction, absorption, interference, and diffraction, which are characteristics of light, for the purpose of increasing visibility, for the purpose of recording and reproduction of an image using a lens, or for the purpose of optical measurement or image propagation or transmission. For example, the optical instrument according to the embodiment may be a cellular phone, a mobile phone, a smartphone, a portable smart device, a digital camera, a laptop computer, a digital broadcasting terminal, a personal digital assistant (PDA), a portable multimedia player (PMP), a navigation device, etc., without being limited thereto, and may also be any of devices for capturing images or pictures.

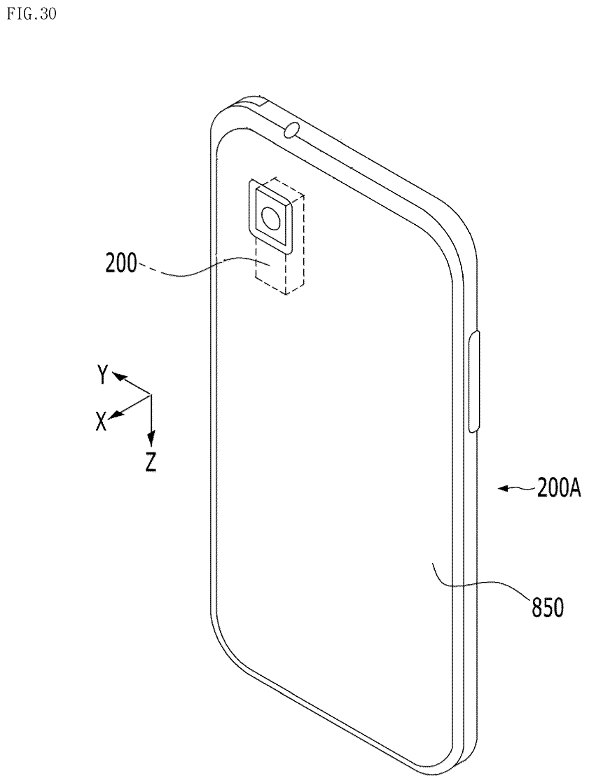

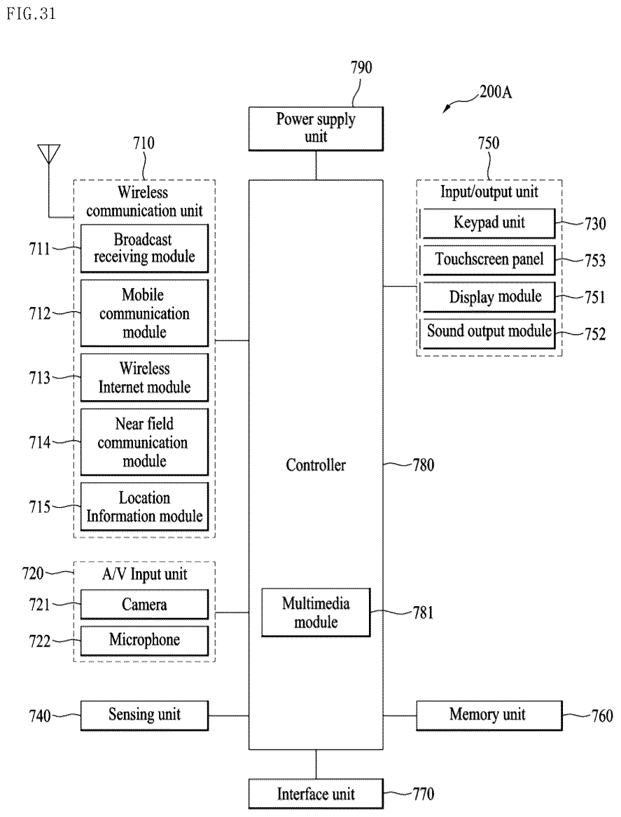

FIG. 30 is a perspective view of an optical instrument 200A according to an embodiment, and FIG. 31 is a configuration diagram of the optical instrument 200A shown in FIG. 30.

Referring to FIGS. 30 and 31, the optical instrument 200A (hereinafter referred to as a portable “terminal”) may include a body 850, a wireless communication unit 710, an A/V input unit 720, a sensing unit 740, an input/output unit 750, a memory unit 760, an interface unit 770, a controller 780, and a power supply unit 790.

The body 850 shown in FIG. 30 may have a bar shape, without being limited thereto, and may be any of various types such as, for example, a slide type, a folder type, a swing type, or a swivel type, in which two or more sub-bodies are coupled so as to be movable relative to each other.

The wireless communication unit 710 may include one or more modules, which enable wireless communication between the terminal 200A and a wireless communication system or between the terminal 200A and a network in which the terminal 200A is located. In an example, the wireless communication unit 710 may include a broadcast receiving module 711, a mobile communication module 712, a wireless Internet module 713, a nearfield communication module 714, and a location information module 715.

The audio/video (A/V) input unit 720 serves to input audio signals or video signals, and may include a camera 721 and a microphone 722.

The camera 721 may include the camera device 200 according to the embodiment.

The sensing unit 740 may sense the current state of the terminal 200A, such as the open or closed state of the terminal 200A, the position of the terminal 200A, the presence or absence of a user's touch, the orientation of the terminal 200A, or the acceleration/deceleration of the terminal 200A, and may generate a sensing signal to control the operation of the terminal 200A. For example, when the terminal 200A is a slide-type phone, whether the slide-type phone is open or closed may be detected. In addition, the sensing unit serves to sense whether power is supplied from the power supply unit 790 or whether the interface unit 770 is coupled to an external device.

The input/output unit 750 serves to generate visual, audible, or tactile input or output. The input/output unit 750 may generate input data to control the operation of the terminal 200A, and may display information processed in the terminal 200A.

The input/output unit 750 may include a keypad unit 730, a display module 751, a sound output module 752, and a touchscreen panel 753. The keypad unit 730 may generate input data in response to input to a keypad.

The display module 751 may include a plurality of pixels, the color of which varies in response to electrical signals. In an example, the display module 751 may include at least one of a liquid crystal display, a thin-film transistor liquid crystal display, an organic light-emitting diode, a flexible display, or a 3D display.

The sound output module 752 may output audio data received from the wireless communication unit 710 in a call-signal receiving mode, a call mode, a recording mode, a voice recognition mode, or a broadcast receiving mode, or may output audio data stored in the memory unit 760.

The touchscreen panel 753 may convert variation in capacitance, caused by a user's touch on a specific region of a touchscreen, into electrical input signals.

The memory unit 760 may store programs for the processing and control of the controller 780, and may temporarily store input/output data (e.g., a phone book, messages, audio, still images, pictures, and moving images). For example, the memory unit 760 may store images captured by the camera 721, for example, pictures or moving images.

The interface unit 770 serves as a passage for connection between the terminal 200A and an external device. The interface unit 770 may receive data or power from the external device, and may transmit the same to respective components in the terminal 200A, or may transmit data inside the terminal 200A to the external device. For example, the interface unit 770 may include a wired/wireless headset port, an external charger port, a wired/wireless data port, a memory card port, a port for connection of a device having an identification module, an audio input/output (I/O) port, a video input/output (I/O) port, and an earphone port.

The controller 780 may control the overall operation of the terminal 200A. For example, the controller 780 may perform control and processing related to voice calls, data communication, and video calls.

The controller 780 may include a multimedia module 781 for multimedia playback. The multimedia module 781 may be provided in the controller 180, or may be provided separately from the controller 780.

The controller 780 may perform pattern recognition processing, by which writing or drawing input to the touchscreen is perceived as characters or images.

The power supply unit 790 may supply power required to operate the respective components upon receiving external power or internal power under the control of the controller 780.

The camera device 200 may be disposed on the body 850 of the portable terminal 200A such that the incident surface 8A of the optical member 40 is disposed parallel to one surface (e.g., rear surface or front surface) of the body 850. In an example, the second actuator 320, the first actuator 310, and the image sensing unit 330 may be arranged in a direction oriented from the upper end of the body 850 of the portable terminal 200A toward the lower end thereof. Another embodiment may be configured such that the camera device disposed as shown in FIG. 30 is rotated at 90 degrees. That is, the second actuator 320, the first actuator 310, and the image sensing unit 330 may be arranged in a direction oriented from a first long side surface of the body 850 of the portable terminal 200A toward a second long side surface thereof. Due to this placement, the embodiments may reduce spatial restrictions when the camera device 200 is mounted in the portable device 200A, and may improve the freedom of design of the portable device.

The features, structures, effects, and the like described above in the embodiments are included in at least one embodiment of the present disclosure, but are not necessarily limited to only one embodiment. Furthermore, the features, structures, effects, and the like exemplified in the respective embodiments may be combined with other embodiments or modified by those skilled in the art. Therefore, content related to such combinations and modifications should be construed as falling within the scope of the present disclosure.

### INDUSTRIAL APPLICABILITY

Embodiments may be used for a camera device capable of preventing damage to the magnetic body support part due to impact and allowing the driving plate to stably support the holder, and an optical instrument including the same.

1. A camera device comprising:
a housing;
a holder disposed in the housing;
an optical member disposed on the holder;
a driving plate disposed between the holder and the housing and configured to support the holder;
a support part spaced apart from the driving plate and coupled to the holder;
a first magnetic body disposed on the support part;
a second magnetic body disposed on the housing so as to face the first magnetic body in a first direction; and
a plate disposed at the support part so as to face the first magnetic body in the first direction.

2. The camera device according to claim 1, wherein the support part comprises a body and an extension portion extending from the body, passing through the housing and being coupled to the holder.

3. The camera device according to claim 1, wherein the plate is disposed at the body of the support part.

4. The camera device according to claim 1, wherein the plate is a magnetic body plate.

5. The camera device according to claim 1, wherein the plate is non-magnetic.

6. The camera device according to claim 2, wherein the first magnetic body is disposed between the second magnetic body and the plate.

7. The camera device according to claim 1, wherein the support part is formed of resin and a plastic and the plate is a metal plate.

8. The camera device according to claim 1, wherein the first magnetic body comprises a first magnet, and the second magnetic body comprises a second magnet, and
wherein a repulsive force acts between the first magnetic body and the second magnetic body.

9. The camera device according to claim 2, wherein the body comprises a magnetic body part facing the first magnetic body in the first direction, and the extension portion is non-magnetic body.

10. The camera device according to claim 1, wherein the plate is a non-magnetic body, and comprise a magnetic body plate facing the first magnetic body in the first direction.

11. The camera device according to claim 2, wherein the plate is disposed at both of the body and the extension portion.

12. The camera device according to claim 1, wherein the plate is disposed inside of the support part.

13. The camera device according to claim 1, wherein the first magnetic body disposed on a front surface of the support part which faces the second magnetic body, and
wherein the plate is disposed on a rear surface of the support part which is opposite to the front surface of the support part.

14. The camera device according to claim 2, wherein the extension portion comprises a first extension portion extending from one side of the body and a second extension portion extending from another side of the body.

15. The camera device according to claim 14, wherein the first extension portion comprises a portion bent at least one from the one side of the body, and the second extension portion comprises a portion bent at least one from the another side of the body.

16. The camera device according to claim 15, wherein the first extension portion and the second extension portion is left and right symmetrical with respect to the body.

17. A camera device comprising:
a housing;
a holder disposed in the housing;
an optical member disposed on the holder;
a driving plate disposed between a first side portion of the holder and the housing and configured to support the holder;
a support part disposed to face the first side portion of the holder and comprising a portion passing through the housing and being coupled to the holder;
a magnet disposed on a second side portion of the holder;
a coil disposed on the housing so as to face the magnet;
a first magnetic body disposed on the support part;
a second magnetic body disposed on the housing so as to face the first magnetic body in a first direction; and
a plate disposed at the support part so as to face the first magnetic body in the first direction.

18. The camera device according to claim 16, wherein the plate comprises a magnetic portion and non-magnetic portion, and
wherein the first magnetic body is closer to the magnetic portion than the non-magnetic portion.

19. The camera device according to claim 18, wherein the magnetic portion is disposed farther from the magnet than the non-magnetic portion.

20. An optical instrument comprising the camera device according to claim 1.
